(19) United States
(12) Patent Application Publication
(10) Pub. No.: US 2018/0059846 A1
(43) Pub. Date: Mar. 1, 2018

(54) TOUCH SENSOR PANEL AND SUBSTRATE

(71) Applicant: FUJIFILM Corporation, Tokyo (JP)

(72) Inventors: Nobuyuki TADA, Kanagawa (JP); Akihiro HASHIMOTO, Kanagawa (JP); Yasushi ENDO, Kanagawa (JP)

(73) Assignee: FUJIFILM Corporation, Tokyo (JP)

(21) Appl. No.: 15/794,990

(22) Filed: Oct. 26, 2017

Related U.S. Application Data
(63) Continuation of application No. PCT/JP2016/061779, filed on Apr. 12, 2016.

(30) Foreign Application Priority Data
May 19, 2015 (JP) 2015-102227

(51) Int. Cl. G06F 3/041; G06F 3/047

(52) U.S. Cl. CPC G06F 3/0412; G02F 1/13338; G06F 3/047; G06F 3/0416

(57) ABSTRACT

A touch sensor panel has a touch sensor portion provided on a substrate, an antenna which is provided on the substrate or near the substrate and transmits and receives a linearly polarized wave, and at least one L-shaped parasitic element provided on the substrate. The touch sensor portion includes a detection portion and a peripheral wiring portion. The L-shaped parasitic element includes two sides intersecting at right angle and is disposed in an appropriate position with respect to the antenna by presetting a length of each of the sides according to a frequency of the linearly polarized wave that the antenna transmits and receives.

### CROSS-REFERENCE TO RELATED APPLICATIONS

This application is a Continuation of PCT International Application No. PCT/JP2016/061779 filed on Apr. 12, 2016, which claims priority under 35 U.S.C. § 119(a) to Japanese Patent Application No. 2015-102227 filed on May 19, 2015. The above application is hereby expressly incorporated by reference, in its entirety, into the present application.

### BACKGROUND OF THE INVENTION

### 1. Field of the Invention

The present invention relates to a touch sensor panel and a substrate which include a parasitic element. Particularly, the present invention relates to a touch sensor panel and a substrate which include a parasitic element receiving a linearly polarized wave transmitted from an antenna and retransmitting the linearly polarized wave as a linearly polarized wave orthogonal to the received linearly polarized wave.

### 2. Description of the Related Art

Currently, mobile terminal apparatuses mounted with a touch panel called a smartphone, a tablet, and the like are being increasingly improved in terms of function, compactified, thinned, and lightened. These mobile terminal apparatuses are mounted with a plurality of antennas such as an antenna for telephone, an antenna for wireless fidelity (WiFi), and an antenna for Blue tooth (registered trademark).

For example, JP2005-86780A describes a communication device mounted with two antennas used for different communication systems. In JP2005-86780A, by disposing an L-shaped parasitic element on each of the two antennas for polarized waves of different directions, the interference between the antennas is prevented.

### SUMMARY OF THE INVENTION

As the mobile terminal apparatuses are compactified, multi-functionalized, and diversified as described above, the usage state of the mobile terminal apparatuses is also diversified. Considering the various states under which the mobile terminal apparatuses are held at the time of use, diversity antennas are desirable as various antennas mounted on the mobile terminal apparatuses. However, because the space for disposing the antennas is restricted, it is difficult to mount a plurality of antennas. In this case, it is difficult for the antennas to maintain a stable performance for all directions. Although the communication device in JP2005-86780A includes two antennas, each of the antennas has a dead zone in a direction of the axis of a polarized wave orthogonal to the plane of the other linearly polarized wave transmitted, and this leads to the problem of the occurrence of communication failure.

Accordingly, there is a demand for a mobile terminal apparatus including an antenna which maintains a stable performance alone for all directions, but currently, there is no such an antenna.

Objects of the present invention are to solve the aforementioned problem of the technique of the related art and to provide a touch sensor panel and a substrate which are improved in terms of the communication performance with respect to a linearly polarized wave orthogonal to the plane of a linearly polarized wave of an antenna.

In order to achieve the aforementioned object, a first aspect of the present invention provides a touch sensor panel comprising a substrate, a touch sensor portion provided on the substrate, an antenna which is provided on the substrate and transmits and receives a linearly polarized wave, and at least one L-shaped parasitic element provided on the substrate, in which the touch sensor portion includes a detection portion and a peripheral wiring portion, and the L-shaped parasitic element has two sides intersecting at right angle and is disposed by presetting a length of each of the sides according to a frequency of the linearly polarized wave that the antenna transmits and receives.

A second aspect of the present invention provides a touch sensor panel comprising a substrate, a touch sensor portion provided on the substrate, an antenna which is provided near the substrate and transmits and receives a linearly polarized wave, and at least one L-shaped parasitic element provided on the substrate, in which the touch sensor portion includes a detection portion and a peripheral wiring portion, and the L-shaped parasitic element has two sides intersecting at right angle and is disposed by presetting a length of each of the sides according to a frequency of the linearly polarized wave that the antenna transmits and receives.

The L-shaped parasitic element and the peripheral wiring portion are preferably formed of the same material.

It is preferable that two L-shaped parasitic elements that are rotationally symmetrical about the antenna are disposed on a front surface or a rear surface of the substrate. Furthermore, a constitution may be adopted in which two L-shaped parasitic elements are rotationally symmetrically disposed on different surfaces of a front surface and a rear surface of the substrate.

In addition, a constitution may be adopted in which two L-shaped parasitic elements are provided, the frequency of the linearly polarized wave corresponding to each of the parasitic elements is different for each of the parasitic elements, and for each of the parasitic elements, the length of each of the sides is preset according to the frequency of the linearly polarized wave of the antenna.

Moreover, a constitution may be adopted in which two sets each including two L-shaped parasitic elements that are rotationally symmetrically disposed are disposed on different surfaces of a front surface and a rear surface of the substrate, the frequency of the linearly polarized wave corresponding to each of the sets is different for each of the sets, and for each of the sets, the length of each of the sides of the parasitic elements is preset according to the frequency of the linearly polarized wave of the antenna.

A third aspect of the present invention provides a substrate disposed near an antenna which transmits and receives a linearly polarized wave, the substrate comprising at least one L-shaped parasitic element, in which the L-shaped parasitic element includes two sides which are formed of a material having conductivity and intersect at right angle, and a length of each of the sides is preset according to a frequency of the linearly polarized wave that the antenna transmits and receives.

It is preferable that two L-shaped parasitic elements that are rotationally symmetrical about the antenna are disposed on a front surface or a rear surface of the substrate. It is preferable that two L-shaped parasitic elements are rotationally symmetrically disposed on different surfaces of a front surface and a rear surface of the substrate.

It is preferable that two L-shaped parasitic elements are provided, the frequency of the linearly polarized wave corresponding to each of the parasitic elements is different for each of the parasitic elements, and for each of the parasitic elements, the length of each of the sides is preset according to the frequency of the linearly polarized wave of the antenna. It is preferable that two sets each including two L-shaped parasitic elements that are rotationally symmetrically disposed are disposed on different surfaces of a front surface and a rear surface of the substrate, the frequency of the linearly polarized wave corresponding to each of the sets is different for each of the sets, and for each of the sets, the length of each of the sides of the parasitic elements is preset according to the frequency of the linearly polarized wave of the antenna.

According to the present invention, it is possible to obtain a touch sensor panel and a substrate which are improved in terms of the communication performance with respect to a linearly polarized wave orthogonal to the plane of a linearly polarized wave of an antenna.

### BRIEF DESCRIPTION OF THE DRAWINGS

FIG. 1 is a schematic view showing the constitution of a mobile terminal apparatus having a touch sensor panel of a first embodiment of the present invention.

FIG. 2 is a schematic plan view showing the touch sensor panel of the first embodiment of the present invention.

FIG. 3 is a schematic cross-sectional view showing the touch sensor panel of the first embodiment of the present invention.

FIG. 4 is a schematic cross-sectional view showing another example of the touch sensor panel of the first embodiment of the present invention.

FIG. 5 is a plan view showing an example of a conductive pattern formed of conductive thin wires.

FIG. 6 is a schematic view for illustrating a parasitic element.

FIG. 7 is a schematic view showing another example of the parasitic element.

FIG. 8 is a schematic plan view showing an example of the disposition of a parasitic element.

FIG. 9 is a schematic perspective view showing another example of the disposition of the parasitic element.

FIG. 10 is a schematic plan view showing a touch sensor panel of a second embodiment of the present invention.

FIG. 11 is a schematic plan view showing an example of the disposition of two parasitic elements.

FIG. 12 is a schematic perspective view showing an example of the disposition of parasitic elements.

FIG. 13 is a schematic perspective view showing another example of the disposition of the parasitic elements.

FIG. 14 is a schematic perspective view showing another example of the disposition of the parasitic elements.

FIG. 15 is a schematic plan view showing an example of the disposition of o parasitic elements on the same surface.

FIG. 16 is a schematic plan view showing an example of the disposition of two parasitic elements on the same surface.

FIG. 17 is schematic plan view showing an example of the disposition of two parasitic elements on the same surface.

FIG. 18 is schematic plan view showing an example of the disposition of two parasitic elements on the same surface.

FIG. 19 is a schematic plan view showing an example of the disposition of an antenna and two parasitic elements on the same surface.

FIG. 20 is a schematic perspective view showing an example of the disposition of a dipole antenna and two L-shaped parasitic elements on the same surface.

FIG. 21 is a schematic perspective view showing an example of the disposition of a dipole antenna and two L-shaped parasitic elements on the same surface.

FIG. 22 is a schematic plan view showing a touch sensor panel of a third embodiment of the present invention.

FIG. 23 is a schematic plan view showing an example of the disposition of a parasitic element.

### DESCRIPTION OF THE PREFERRED EMBODIMENTS

Hereinafter, the touch sensor panel and the substrate of the present invention will be specifically described based on suitable embodiments shown in the attached drawings.

In the following description, “to” showing a range of numerical values includes the numerical values listed before and after “to”. For example, in a case where ε is between a numerical value a and a numerical value β, the range of ε includes the numerical value α and the numerical value β, which is represented by mathematical symbols of α≦ε≦β.

An “optically transparent” substance and a simply “transparent” substance both have a light transmittance of at least equal to or higher than 60% in the wavelength region of visible light at a wavelength of 400 to 800 nm. The light transmittance is preferably equal to or higher than 75%, more preferably equal to or higher than 80%, and even more preferably equal to or higher than 85%.

The light transmittance is measured using “Testing methods for total light transmittance and total light reflectance of plastics” specified in JIS K 7375:2008, for example.

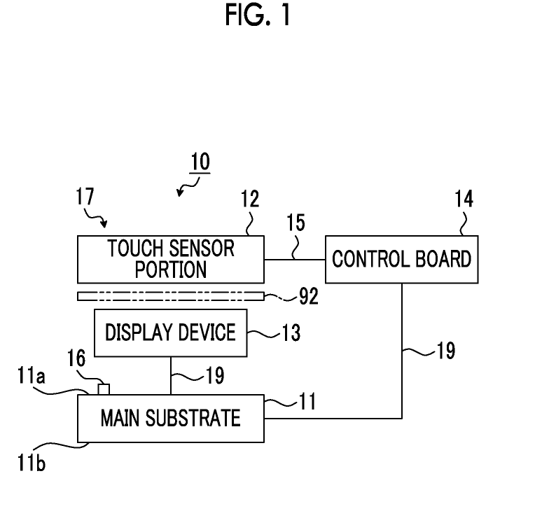

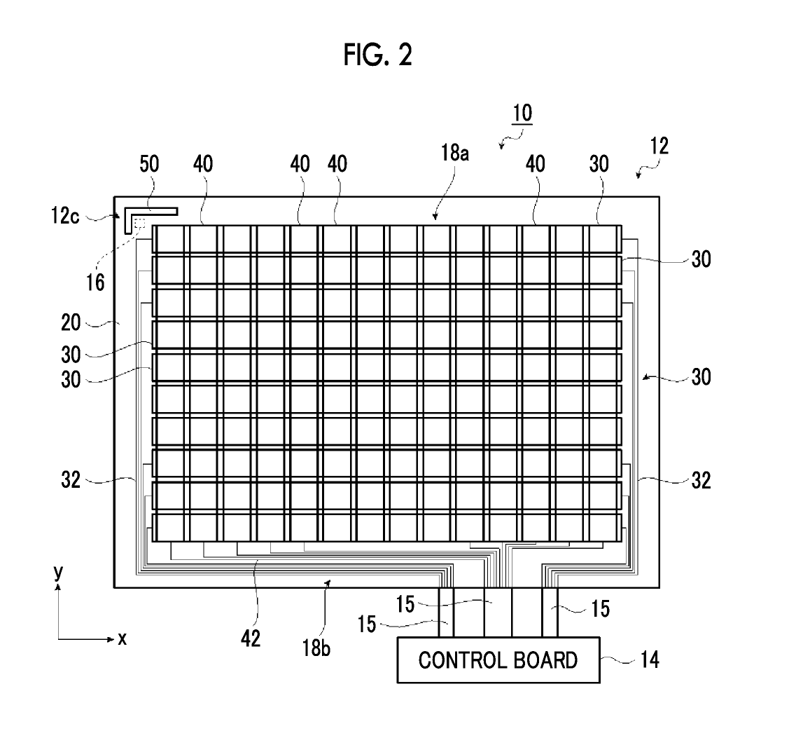

FIG. 1 is a schematic view showing the constitution of a mobile terminal apparatus having the touch sensor panel of the first embodiment of the present invention. FIG. 2 is a schematic plan view showing the touch sensor panel of the first embodiment of the present invention.

A touch sensor panel 10 shown in FIGS. 1 and 2 is used in a mobile terminal apparatus mounted with a touch panel, together with a display device 13 such as a liquid crystal display device. The touch sensor panel 10 is provided on the display device 13. Therefore, in the touch sensor panel 10, a region corresponding to an image displayed by the display device 13 is transparent such that the image displayed by the display device 13 is recognized. The display device 13 is not particularly limited as long as a predetermined image including a motion picture or the like can be displayed on a screen. In addition to the aforementioned liquid crystal display device, for example, an organic electro luminescence (EL) display device, electronic paper, and the like can be used.

A mobile terminal apparatus 17, which is mounted with a touch panel that allows communication, is constituted with the touch sensor panel 10 and the display device 13.

The touch sensor panel 10 shown in FIG. 1 has a touch sensor portion 12 and a control board 14 controlling the touch sensor portion 12. The display device 13 is disposed between the touch sensor portion 12 and a main substrate 11. In a case where a shielding plate (not shown in the drawing) made of aluminum is used as the display device 13 as in a liquid crystal display device, within a front surface 11 a of the main substrate 11, an antenna 16 is provided in a position where the display device 13 is not disposed, lest the antenna 16 is affected by the shielding plate.

The distance between the touch sensor portion 12 and the main substrate 11 is generally about 1 to 5 mm. The periphery of the antenna 16 is filled with air, a printed substrate, and other insulating media.

As shown in FIGS. 1 and 2, the touch sensor portion 12 and the control board 14 are electrically connected to each other through flexible printed circuit (FPC) 15, for example. The electric connection between the touch sensor portion 12 and the control board 14 is not limited to the flexible printed circuits 15, and the touch sensor portion 12 and the control board 14 may also be electrically connected to each other through a connector (not shown in the drawing). The main substrate 11 and the display device 13 are electrically connected to each other through flexible printed circuits (FPC) 19, for example. The main substrate 11 and the control board 14 are electrically connected to each other through flexible printed circuits (FPC) 19, for example.

The main substrate 11 is mounted with a control circuit (not shown in the drawing) that controls the display device 13, the control board 14, and data communication though the antenna 16. The control circuit is constituted with an electronic circuit, for example. Due to the control circuit (not shown in the drawing) mounted on the main substrate 11, the antenna 16 can transmit a transmission signal and receive a reception signal, and information can be exchanged with external apparatuses.

The control board 14 has a control circuit (not shown in the drawing) for the touch sensor portion 12 and a communication circuit (not shown in the drawing) with the main substrate 11.

In a case where a sensor portion 18a, which will be specifically described later, of the touch sensor portion 12 is touched with a finger or the like, a change in capacitance occurs in the touched position if the touch sensor portion is a capacitance type. The change in capacitance is detected by the control board 14, and the coordinates of the touched position are specified. The control board 14 is constituted with a known device used for position detection in a general touch panel. In a case where the touch sensor portion 12 is a capacitance type, a capacitance-type control circuit is used. Furthermore, in a case where the touch sensor portion 12 is a resistive film type, a resistive film-type control circuit is appropriately used.

In the main substrate 11, as the control circuit controlling the display device 13 and the control circuit controlling data communication, known circuits can be appropriately used.

The x-axis direction and the y-axis direction shown in FIG. 2 are orthogonal to each other. In the touch sensor portion 12 of the touch sensor panel 10, a plurality of first conductive layers 30 extending in the x-axis direction are disposed in the y-axis direction at an interval. Furthermore, a plurality of second conductive layers 40 extending in the y-axis direction are disposed in the x-axis direction at an interval.

One end of each of the first conductive layers 30 is electrically connected to first wiring 32. The first wiring 32 is each connected to the control board 14 through the flexible printed circuits 15.

One end of each of the second conductive layers 40 is electrically connected to second wiring 42. The second wiring 42 is each connected to the control board 14 through the flexible printed circuits 15. For some of the first conductive layers 30, the first wiring 32 connected thereto is not shown in the drawing. For some of the second conductive layers 40, the second wiring 42 connected thereto is not shown in the drawing.

The first conductive layer 30 and the second conductive layer 40 both function as a detection electrode detecting a touch that occurs on the touch sensor panel 10. The sensor portion 18a detecting a touch is constituted with the first conductive layers 30 and the second conductive layers 40. The first wiring 32 and the second wiring 42 are collectively referred to as a peripheral wiring portion 18b.

The first conductive layers 30 and the second conductive layers 40 have the same constitution, and the first wiring 32 and the second wiring 42 have the same constitution.

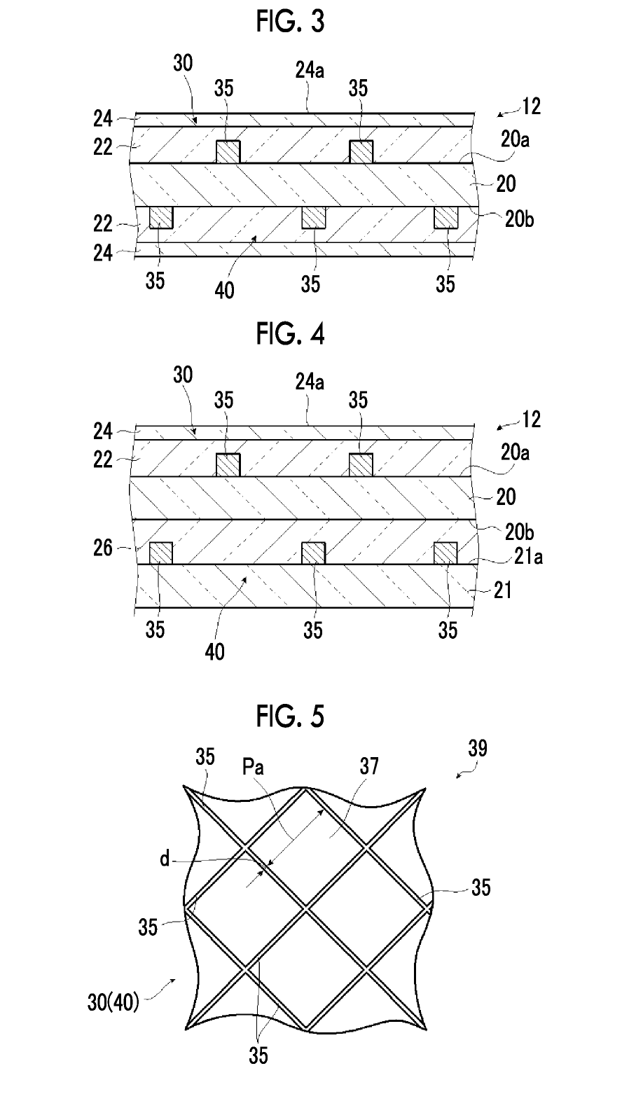

As shown in FIG. 3, in the touch sensor portion 12, the first conductive layer 30 is formed on a front surface 20a of a substrate 20, and the second conductive layer 40 is formed on a rear surface 20b of the substrate 20. A protective layer 24 is provided on the first conductive layer 30 through an adhesive layer 22. The protective layer 24 is provided on the second conductive layer 40 through the adhesive layer 22.

The first wiring 32 is formed on the front surface 20a of the substrate 20 on which the first conductive layer 30 is formed, although the first wiring 32 is not shown in FIG. 3. Furthermore, the second wiring 42 is formed on the rear surface 20b of the substrate 20 on which the second conductive layer 40 is formed, although the second wiring 42 is not shown in FIG. 3.

By forming the first conductive layer 30 on the front surface 20a of a single substrate 20 and forming the second conductive layer 40 on the rear surface 20b, even though the substrate 20 contracts, it is possible to reduce the dislocation between the first conductive layer 30 and the second conductive layer 40 in the positional relationship thereof.

The touch sensor panel 10 may have a constitution in which one conductive layer is provided on a single substrate 20, for example. As in the touch sensor portion 12 shown in FIG. 4, a constitution may also be adopted in which on the rear surface 20b of a single substrate 20 with the front surface 20a on which the first conductive layer 30 is formed, a substrate 21 with a front surface 21a on which the second conductive layer 40 is formed through an adhesive layer 26 may be laminated. In this case, the protective layer 24 is provided on the first conductive layer 30 through the adhesive layer 22. The substrate 21 and the substrate 20 have the same constitution.

As shown in FIG. 5, the first conductive layer 30 and the second conductive layer 40 are each constituted with conductive thin wires 35.

A line width d of each conductive thin wire 35 is preferably equal to or greater than 0.1 μm and equal to or smaller than 5 μm, and more preferably equal to or greater than 0.5 μm and equal to or smaller than 4 μm. In a case where the line width d of the conductive thin wire 35 is within the above range, the resistance of the first conductive layer 30 and the second conductive layer 40 can be relatively easily lowered.

The thickness of each conductive thin wire 35 is not particularly limited, but is preferably 0.1 μm to 10 μm and most preferably 0.5 μm 5 μm. In a case where the thickness of each conductive thin wire 35 is within the above range, the first conductive layer 30 and the second conductive layer 40 having low resistance and excellent durability can be relatively easily obtained.

The line width d and the thickness of each conductive thin wire 35 can be measured using an optical microscope, a laser microscope, a digital microscope, and the like, for example.

In FIG. 2, the first conductive layer 30 and the second conductive layer 40 are both schematically shown in the form of a rod. However, as shown in FIG. 5, for example, the first conductive layer 30 and the second conductive layer 40 have a mesh pattern 39 obtained by combining a large number of cells 37 constituted with the conductive thin wires 35.

Each cell 37 has the shape of a polygon, for example. Examples of the polygon include a triangle, a quadrangle such as a square, a rectangle, a parallelogram, or a rhombus, a pentagon, a hexagon, a random polygon, and the like. Some of the sides constituting the polygon may be a curve.

In a case where a length Pa of one side of each cell 37 of the mesh pattern 39 is too small, an opening ratio and a transmittance are reduced, and this leads to a problem of the deterioration of transparency. In contrast, in a case where the length Pa of one side of each cell 37 is too large, the touch position is unlikely to be detected at high resolution.

The length Pa of one side of each cell 37 of the mesh pattern 39 is not particularly limited, but is preferably 50 to 500 μm and more preferably 100 to 400 μm. In a case where the length Pa of one side of each cell 37 is within the above range, the transparency can be kept excellently. In a case where such a mesh pattern is provided on the front surface of a display device, the display can be recognized without discomfort.

In view of visible light transmittance, the opening ratio of the mesh pattern 39 formed of the conductive thin wires 35 is preferably equal to or higher than 80%, more preferably equal to or higher than 85%, and most preferably equal to or higher than 90%. The opening ratio is a proportion of a light-transmitting portion in the entire pattern excluding the conductive thin wires 35.

By making the first conductive layer 30 and the second conductive layer 40 have a mesh structure in which the conductive thin wires 35 cross each other and form a mesh shape, the resistance can be reduced, and the wires are hardly broken. Furthermore, even in a case where wires are broken, it is possible to reduce the influence on the value of resistance of the detection electrode.

Regarding the mesh structure, the mesh shape may be either a regular shape in which the same patterns are regularly arrayed or a random shape. The regular shape is preferably a square shape, a rhombic shape, or a regular hexagonal shape, and particularly preferably a rhombic shape. For the rhombic shape, from the viewpoint of reducing moire with the display device, an acute angle of the rhombus is preferably 50° to 80°. The mesh pitch is preferably 50 μm to 500 μm, and the opening ratio of the mesh is preferably 82% to 99%. The opening ratio of the mesh is defined as the ratio of an area not being occupied by the conductive thin wires within the mesh portion.

As a mesh-like metal electrode, for example, it is possible to use the netlike mesh-type metal electrodes disclosed in JP2011-129501A, JP2013-149236A, and the like. In addition, for example, it is possible to appropriately use detection electrodes used in capacitance-type touch panels.

The length Pa of one side of each cell 37, the angle of the mesh, and the opening ratio of the mesh can be measured using an optical microscope, a laser microscope, a digital microscope, and the like, for example.

The thickness of the peripheral wiring portion 18b is not particularly limited, but is preferably 0.1 μm to 0.2 mm and most preferably 0.5 μm to 35 μm. In a case where the thickness of the peripheral wiring portion 18b is within the above range, it is possible to relatively easily obtain the first wiring 32 and the second wiring 42 having low resistance and excellent durability.

Similarly to the conductive thin wire 35, the thickness of the peripheral wiring portion 18b can be measured using an optical microscope, a laser microscope, a digital microscope, and the like, for example.

The conductive thin wires 35, the peripheral wiring portion 18b, a parasitic element 50, an antenna 70 which will be described later, and a ground wire 72 which will be described later are constituted with a conductive material such as a metal, an alloy, or a compound. For the conductive thin wires 35, the peripheral wiring portion 18b, the parasitic element 50, the antenna 70 which will be described later, and the ground wire 72 which will be described later, the materials generally used as a conductor can be appropriately used, and the composition thereof is not particularly limited. The conductive thin wires 35, the peripheral wiring portion 18b, the parasitic element 50, the antenna 70 which will be described later, and the ground wire 72 which will be described later are formed of indium tin oxide (ITO), gold (Au), silver (Ag), copper (Cu), nickel (Ni), titanium (Ti), palladium (Pd), platinum (Pt), aluminum (Al), tungsten (W), or molybdenum (Mo), for example. An alloy of these may also be used. The conductive thin wire 35, the peripheral wiring portion 18b, the parasitic element 50, the antenna 70 which will be described later, and the ground wire 72 which will be described later may be constituted with gold (Au), silver (Ag), or copper (Cu) with a binder, and those constituted in this way are also included in the conductive thin wires 35, the peripheral wiring portion 18b, the parasitic element 50, the antenna 70 which will be described later, and the ground wire 72 which will be described later. By containing a binder, the conductive thin wires 35, the peripheral wiring portion 18b, the parasitic element 50, the antenna 70 which will be described later, and the ground wire 72 which will be described later are easily subjected to a bending process and improved in terms of bending resistance. As the binder, those used as wiring of conductive films can be appropriately used, and for example, those described in JP2013-149236A can be used. In a case where the conductive thin wires 35 are constituted with a metal or an alloy, the conductive thin wires 35 are metal thin wires.

As the adhesive layer 22, for example, an optically transparent pressure sensitive adhesive called an optically clear adhesive (OCA) or an optically transparent resin such as an ultraviolet-curable resin called an optically clear resin (OCR) is used.

The protective layer 24 is for protecting the first conductive layer 30, the second conductive layer 40, the first wiring 32, the second wiring 42, the parasitic element 50, the antenna 70 which will be described later, and the ground wire 72 which will be described later. The constitution of the protective layer 24 is not particularly limited, and for example, glass, polycarbonate (PC), polyethylene terephthalate (PET), an acrylic resin (PMMA), and the like can be used.

In the touch sensor panel 10, as shown in FIG. 1, the antenna 16 is provided on the front surface 11a of the main substrate 11, in a position corresponding to a corner portion 12c (see FIG. 2) of the touch sensor portion 12.

The antenna 16 receives and transmits a linearly polarized wave. The constitution of the antenna 16 is not particularly limited, and for example, a chip antenna is used. The chip antenna has a structure in which a coil is formed around a core of a medium with a high dielectric constant such as ceramic and the coil is covered with plastic. As the antenna 16, according to the specification and the like, it is possible to use antennas of various constitutions such as a linear antenna, a patch antenna, and any antenna including the modification of the aforementioned antennas. As the antenna 16, in addition to the chip antenna, a dipole antenna and a monopole antenna can be used.

The L-shaped parasitic element 50 is provided on the front surface 20a of the substrate 20. The parasitic element 50 is simply formed on the substrate 20 and in a floating state, but is not connected to any member including the antenna 16 through a conductor or the like. However, the parasitic element 50 and the antenna 16 interact with each other and are electrically bonded to each other. The parasitic element 50 and the antenna 16 function as a single integrated antenna.

By interacting with the antenna 16, the parasitic element 50 improves the communication performance with respect to a linearly polarized wave orthogonal to the plane of a linearly polarized wave of the antenna 16. The parasitic element 50 does not have to be provided only on the front surface 20a of the substrate 20 and may be provided on the rear surface 20b of the substrate 20.

The parasitic element 50 can convert a portion of energy of the linearly polarized wave transmitted from the antenna 16 into energy of a linearly polarized wave orthogonal to the plane of the linearly polarized wave and retransmit the linearly polarized wave. The parasitic element 50 converts the energy of the received linearly polarized wave into the energy of a linearly polarized wave orthogonal to the plane of a linearly polarized wave and retransmits the linearly polarized wave. Therefore, by being combined with the parasitic element 50, the antenna 16 can receive the linearly polarized wave orthogonal to the linear polarization plane of the antenna 16. As a result, the communication performance with respect to the linearly polarized wave orthogonal to the linear polarization plane of the antenna 16 is improved.

The parasitic element 50 is constituted with a conductor. The parasitic element 50 can be constituted with the same material as the conductive thin wires 35 or the peripheral wiring portion 18b. Therefore, the detailed description of the constitution of the parasitic element 50 will not be repeated. The thickness of the parasitic element 50 may be the same as the thickness of the conductive thin wire 35 or the peripheral wiring portion 18b. That is, the thickness of the parasitic element 50 may be the same as the thickness of the first conductive layer 30 and the second conductive layer 40 of the touch sensor portion 12 or the thickness of the first wiring 32 and the second wiring 42.

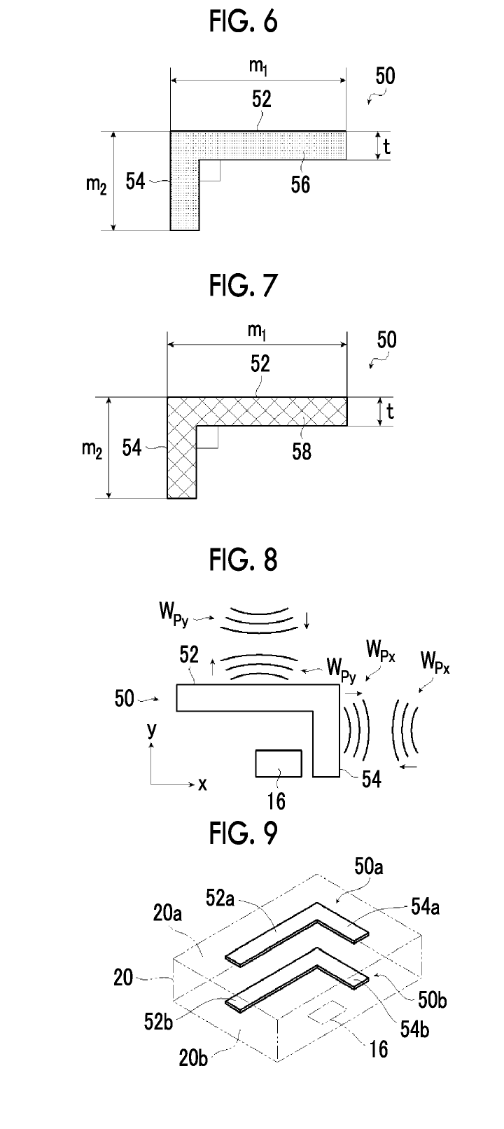

As shown in FIG. 6, the parasitic element 50 is an L-shaped member having two sides including a long side 52 and a short side 54 intersecting at right angle. The parasitic element 50 is constituted with a foil-like conductor 56 having a width t, for example. The foil-like conductor 56 is a planar film called a solid film.

As shown in FIG. 7, the parasitic element 50 may be constituted with a mesh-like conductor 58 having a width t constituted with the conductive thin wires 35 or the peripheral wiring portion 18b described above.

Two sides of the parasitic element 50 including the long side 52 and the short side 54 intersect at right angle. Regarding the parasitic element 50, the “right angle” is preferably 90° from the viewpoint of directivity, but manufacturing errors are accepted. In this case, the acceptable errors are about right angle ±10°, that is, 90°±10°.

A length m₁ of the long side 52 and a length m₂ of the short side 54 of the parasitic element 50 are appropriately set according to the constitution of the antenna 16. The sum of the length m₁ and the length m₂ is a length corresponding to a ½ wavelength resonates at the frequency of the linearly polarized wave that the antenna 16 transmits and receives. The ratio m₁/m₂ between the length m₁ and the length m₂ is preset.

The parasitic element 50 is disposed with respect to the antenna 16 such that the receiving sensitivity of the antenna 16 in a direction in which the antenna 16 exhibits low receiving sensitivity is improved.

The receiving sensitivity of the antenna 16 with respect to a linearly polarized wave Wpx in the y-axis direction is relatively lower than the receiving sensitivity of the antenna 16 with respect to a linearly polarized wave Wpy in the x-axis direction. In this case, as shown in FIG. 8, the parasitic element 50 is disposed such that the long side 52 becomes parallel to the linearly polarized wave Wpy in the x-axis direction.

At this time, the distance between the central axis (not shown in the drawing) of the linearly polarized wave of the antenna 16 and the central axis (not shown in the drawing) of the long side 52 of the parasitic element 50 in the y-axis direction is within a range of 0 mm to 20 mm and desirably 0 mm to 10 mm.

In the x-axis direction, the parasitic element 50 is positioned with respect to the antenna 16, such that the central axis (not shown in the drawing) of the short side 54 of the parasitic element 50 crosses the antenna 16 or is within a range of 50 mm from the end of the antenna 16.

In this state, in the short side 54 on which the linearly polarized wave Wpx in the y-axis direction reaches the parasitic element 50, an induced current that occurs along the y-axis direction spreads over the entirety of the parasitic element 50. Due to the induced current, from the long side 52, the linearly polarized wave is retransmitted as the linearly polarized wave Wpy in the x-axis direction and received by the antenna 16. In this way, the receiving sensitivity of the antenna 16 with respect to the linearly polarized wave Wpx in the y-axis direction can be improved. In the parasitic element 50, the linearly polarized wave Wpx in the y-axis direction can be converted into the linearly polarized wave Wpy in the x-axis direction.

In a case where the linearly polarized wave transmitted from the antenna 16, the parasitic element 50 resonates due to the linearly polarized wave Wpy in the x-axis direction, an induced current occurs in the long side 52 along the x-axis direction, and the linearly polarized wave Wpx in the y-axis direction is transmitted from the short side 54. In this way, a portion of energy of the linearly polarized wave transmitted from the antenna 16 can be converted into the energy of the linearly polarized wave orthogonal to the plane of a linearly polarized wave and retransmitted, and it is possible to reduce the direction in which the antenna 16 has a dead zone due to the direction of the polarized wave during the transmission and reception of a linearly polarized wave by the antenna 16. That is, the communication performance with respect to a linearly polarized wave orthogonal to the plane of a linearly polarized wave of the antenna 16 is improved. Accordingly, even in a case where it is difficult to mount a plurality of antennas due to the restriction on the space for disposing antennas and hence only one antenna 16 is used, the antenna can maintain a stable performance for all directions.

As described above, the antenna 16 and the parasitic element 50 function as a single integrated antenna, that is, an antenna for both the linearly polarized wave and the cross-polarized wave. The antenna 16 and the parasitic element 50 resonate, and due to the linearly polarized wave transmitted from the antenna 16, an induced current occurs within the parasitic element 50. In addition to the linearly polarized wave transmitted from the antenna 16, a linearly polarized wave orthogonal to the linearly polarized wave transmitted from the antenna 16 is transmitted from the parasitic element 50. That is, the same effect as being obtained from a diversity antenna is obtained. Therefore, unlike in a case where diversity antennas and complicated circuits for controlling them are used for the purpose of avoiding a dead zone resulting from the direction of a polarized wave of the antennas that transmit and receive a linearly polarized wave, substantially all directions can be covered by a single combination of the antenna 16 and the parasitic element 50. Accordingly, the antenna-switching function of a transceiver circuit is not required, and a stabilized performance can be maintained for all directions with a simple structure. In addition, the L-shaped parasitic element 50 can be accommodated in the touch sensor panel 10.

By changing the ratio m₁/m₂ between the length m₁ of the long side 52 and the length m₂ of the short side 54 of the parasitic element 50, it is possible to adjust the intensity of two linearly polarized waves orthogonal to each other that are transmitted from the entirety of the antenna 16 and the parasitic element 50.

Furthermore, according to the positional relationship between the antenna 16 and the parasitic element 50, it is possible to adjust the intensity and the phase of two linearly polarized waves orthogonal to each other that are transmitted from the entirety of the antenna 16 and the parasitic element 50. A polarized wave obtained by synthesizing two linearly polarized waves orthogonal to each other becomes a new linearly polarized wave different from the linearly polarized wave of the antenna 16, an elliptically polarized wave, or a mixed polarized wave of a new linearly polarized wave different from the linearly polarized wave of the antenna 16 and an elliptically polarized wave.

In a case where the antenna 16 is a wideband antenna which can receive two different frequencies for example, as shown in FIG. 9, by providing two parasitic elements including a first parasitic element 50a and a second parasitic element 50b, it is possible to enhance the receiving sensitivity and to improve the communication performance with respect to a linearly polarized wave orthogonal to the plane of a linearly polarized wave of the antenna 16.

The first parasitic element 50a and the second parasitic element 50b are disposed on different surfaces of the substrate 20. For example, the first parasitic element 50a is provided on the front surface 20a of the substrate 20, while the second parasitic element 50b is provided on the rear surface 20b of the substrate 20.

The frequency of the linearly polarized wave corresponding to each of the first parasitic element 50a and the second parasitic element 50b is different for each of the first parasitic element 50a and the second parasitic element 50b. Similarly to the aforementioned parasitic element 50, the length of a long side 52a and a short side 54a of the first parasitic element 50a as well as a long side 52b and the length of a short side 54b of the second parasitic element 50b and a ratio between the lengths are preset according to the frequency of the linearly polarized wave to be received.

The method for forming the first conductive layer 30, the first wiring 32, the second conductive layer 40, the second wiring 42, and the parasitic element 50 is not particularly limited. For example, a wiring formation method using a plating method may be used. In the plating method, only electroless plating may be performed, or electrolytic plating may be performed after electroless plating. The wiring formation method using a plating method may be a subtractive method, a semi-additive method, or a full additive method. Furthermore, the first conductive layer 30, the first wiring 32, the second conductive layer 40, the second wiring 42, and the parasitic element 50 can be formed by performing exposure on a photosensitive material having an emulsion layer containing a photosensitive silver halide salt and performing a development treatment. In addition, by forming metal foil on the substrate 20, printing a resist pattern-wise on each metal foil or performing exposure on a resist applied onto the entire surface of the substrate, performing development to form a pattern, and etching the metal in the opening portion, the first conductive layer 30, the first wiring 32, the second conductive layer 40, the second wiring 42, and the parasitic element 50 can be formed. Examples of other formation methods include a method of performing printing by using a paste containing fine particles of the material constituting the aforementioned conductors and plating the paste with a metal and a method of using an ink jet method in which ink containing fine particles of the material constituting the aforementioned conductors is used.

The first conductive layer 30, the first wiring 32, and the parasitic element 50 are formed on the same surface. In a case where the first conductive layer 30 and the first wiring 32 are formed through exposure, by using an exposure pattern as a pattern for each portion, the first conductive layer 30, the first wiring 32, and the parasitic element 50 can be collectively formed. In this way, the manufacturing process can be simplified, and the manufacturing costs can be reduced. In addition, the first conductive layer 30, the first wiring 32, and the parasitic element 50 can be formed of the same material. Furthermore, in a case where the first conductive layer 30 and the first wiring 32 as well as the second conductive layer 40 and the first wiring 32 are formed by simultaneously performing exposure on both surfaces of the substrate 20, the second conductive layer 40 can also be collectively formed. Accordingly, the production efficiency can be further improved, and the manufacturing costs can be further reduced.

Herein, the same material means that the type and content of the compositional components are identical. “Identical” means that the type of the compositional components is the same. For the content, “identical” means that a margin of error of ±10% is acceptable. Furthermore, for example, in a case where the first conductive layer 30, the first wiring 32, and the parasitic element 50 are formed of the same material through the same step, it is said that they are formed of the same material. The composition and content can be measured using an X-ray fluorescence analyzer, for example.

It goes without saying that all of the parasitic element 50, the sensor portion 18a and the peripheral wiring portion 18b do not have to be formed of the same material, and can be formed of different materials at different thicknesses.

For the sake of manufacturing, it is desirable that the parasitic element 50 is disposed on the front surface or the rear surface of the substrate of the touch sensor portion 12. However, because the function of the parasitic element 50 never depends on the sensor portion 18a and the peripheral wiring portion 18b, the disposition site of the parasitic element 50 is not limited to the touch sensor portion 12.

Next, a second embodiment of the touch sensor panel will be described.

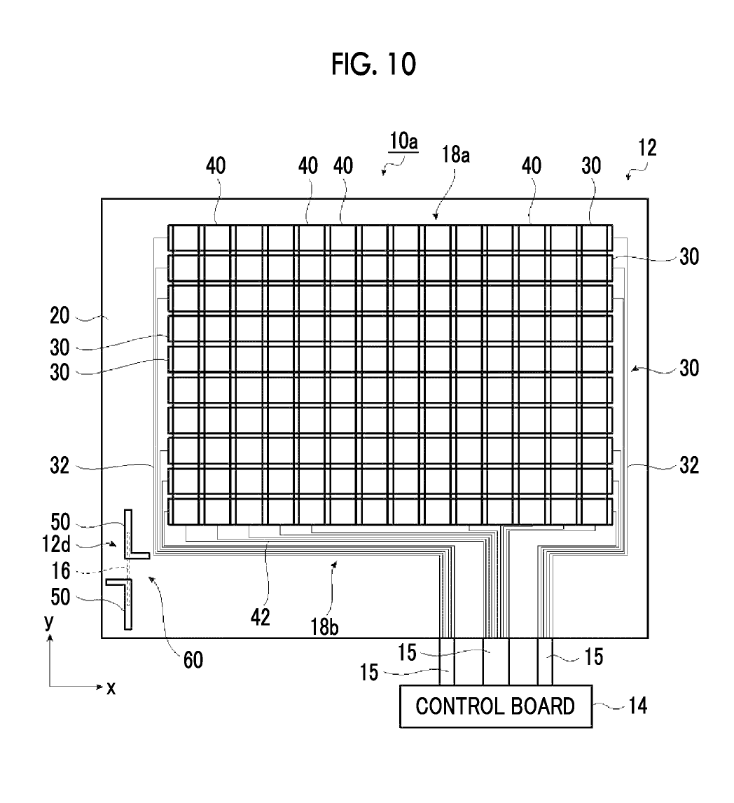

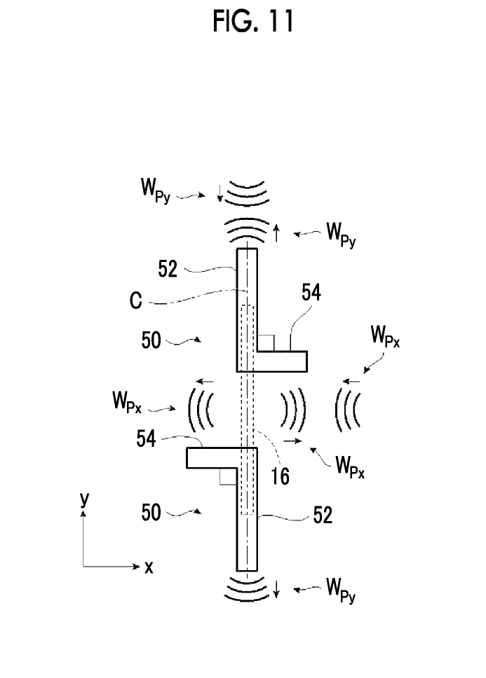

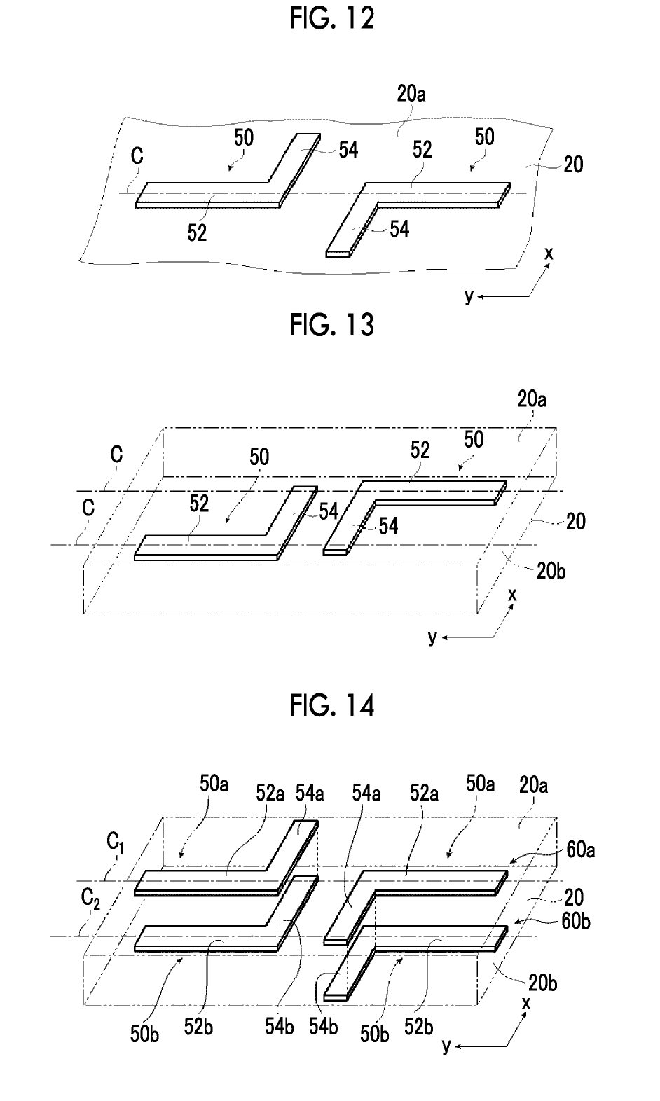

FIG. 10 is a schematic plan view showing a touch sensor panel of the second embodiment of the present invention. FIG. 11 is a schematic plan view showing an example of the disposition of two parasitic elements. FIG. 12 is a schematic perspective view showing an example of the disposition of parasitic elements. FIG. 13 is a schematic perspective view showing another example of the disposition of the parasitic elements. FIG. 14 is a schematic perspective view showing another example of the disposition of parasitic elements.

In FIGS. 10, 11, and 12 to 14, the same constituents as the touch sensor panel 10 of the first embodiment shown in FIGS. 1 and 2, the touch sensor portion 12 of the first embodiment shown in FIGS. 3 to 5, and the parasitic element 50 of the first embodiment shown in FIGS. 6 and 7 will be marked with the same references, and the detailed description thereof will not be repeated. In FIG. 10, for some of the first conductive layers 30, the first wiring 32 connected thereto is not shown. Furthermore, for some of the second conductive layers 40, the second wiring 42 connected thereto is not shown in the drawing.

A touch sensor panel 10a of the present embodiment shown in FIG. 10 has the same constitution as the touch sensor panel 10 (see FIG. 2) of the first embodiment, except that the disposition position of the antenna 16 is different from that of the antenna 16 in the touch sensor panel 10 (see FIG. 2) of the first embodiment, and that two parasitic elements 50 are provided in the touch sensor panel 10a. Therefore, the detailed description of the constitution of the touch sensor panel 10a will not be repeated.

In the touch sensor panel 10a, the antenna 16 is provided in a position 12d in which the display device 13 is not provided within the front surface 11a (see FIG. 1) of the main substrate 11, although the front surface 11a and the main substrate 11 are not shown in the drawing. Two parasitic elements 50 are provided in a position where they are rotationally symmetrical about the antenna 16.

Herein, the receiving sensitivity of the antenna 16 with respect to the linearly polarized wave Wpy in the x-axis direction is relatively lower than the receiving sensitivity of the antenna 16 with respect to the linearly polarized wave Wpx in the y-axis direction. In this case, as shown in FIG. 11, two parasitic elements 50 are disposed such that the antenna 16 is interposed therebetween, and that each long sides 52 passes through the antenna 16 and is aligned along a straight line C parallel to the y-axis direction. The straight line C corresponds to the plane of a linearly polarized wave of the antenna 16. Two parasitic elements 50 are collectively referred to as a set 60.

It is desirable that the antenna 16 and two parasitic elements 50 have a positional relationship such that one side of each of the L-shaped parasitic elements is aligned with the C-axis, which is the direction of the linearly polarized wave of the antenna 16, and passes the center of the linearly polarized wave of the antenna 16, and that the other side of each of the L-shaped parasitic elements is aligned along a direction perpendicular to the linearly polarized wave. The positional relationship is not strict, and as long as intended characteristics are obtained, a slight deviation is acceptable.

The acceptable deviation represented by a distance between the central axis (not shown in the drawing) of the linearly polarized wave of the antenna 16 and the central axis (not shown in the drawing) of the long side 52 of two parasitic elements 50 in the x-axis direction (shown in FIG. 11) is within a range of 0 mm to 20 mm and desirably 0 mm to 10 mm, although the acceptable deviation also depends on the frequency used for transmission and reception, the thickness of an insulating medium interposed between the antenna 16 and two parasitic elements 50, and the dielectric constant of the insulating medium.

Likewise, the acceptable deviation represented by a distance between a straight line (not shown in the drawing), which passes a spot where a current distribution maximized within the antenna 16 and is perpendicular to the central axis of the linearly polarized wave of the antenna 16, and the central axis (not shown in the drawing) of the short side 54 of two parasitic elements 50 in the y-axis direction is within a range of 0 mm to 100 mm, desirably 0 mm to 50 mm, and most desirably 0 mm to 20 mm (shown in FIG. 11).

Two parasitic elements 50 receive the linearly polarized wave Wpy in the x-axis direction by using the short side 54. In a case where the linearly polarized wave Wpy in the x-axis direction reaches the parasitic elements 50, an induced current that occurs in the short side 54 of the parasitic elements 50 along the x-axis direction spreads over the entirety of the parasitic elements 50. Due to the induced current, the linearly polarized wave is retransmitted from the long side 52 as the linearly polarized wave Wpx in the y-axis direction and received by the antenna 16. In this way, the receiving sensitivity of the antenna 16 with respect to the linearly polarized wave Wpy in the x-axis direction can be improved.

In two parasitic elements 50, the linearly polarized wave Wpy in the x-axis direction can be converted into the linearly polarized wave Wpx in the y-axis direction.

In a case where a linearly polarized wave is transmitted from the antenna 16, due to the linearly polarized wave Wpx in the y-axis direction, an induced current occurs in the long side 52 of the parasitic elements 50 in the x-axis direction and spreads over the entirety of the parasitic elements 50. Due to the induced current, the linearly polarized wave Wpy in the x-axis direction is transmitted from the short side 54, and the linearly polarized waves Wpx and Wpy are transmitted mainly from the antenna 16 in four directions. In this way, the linearly polarized wave can be retransmitted by converting a portion of energy of the linearly polarized wave transmitted from the antenna 16 into the energy of a linearly polarized wave orthogonal to the plane of the linearly polarized wave, and it is possible to reduce the direction that becomes a dead zone resulting from the direction of the polarized wave along which the antenna 16 transmits and receives the linearly polarized wave. That is, it is possible to further improve the communication performance with respect to a linearly polarized wave orthogonal to the plane of a linearly polarized wave of the antenna 16. As a result, even in a case where it is difficult to mount a plurality of antennas due to the restriction on the space for disposing antennas and hence only one antenna 16 is used, it is possible to more reliably maintain the stable performance for all directions than in a case where only one parasitic element 50 is used.

As described above, the antenna 16 and two parasitic elements 50 function as a single integrated antenna, that is, an antenna used for both the linearly polarized wave and the cross-polarized wave. The antenna 16 and two parasitic elements 50 resonate, and an induced current occurs in two parasitic elements 50 due to the linearly polarized wave transmitted from the antenna 16. As a result, in addition to the linearly polarized wave transmitted from the antenna 16, a linearly polarized wave orthogonal to the linearly polarized wave transmitted from the antenna 16 is transmitted from the parasitic elements 50. In this case, the linearly polarized wave orthogonal to the linearly polarized wave transmitted from the antenna 16 is transmitted more than in a case where one parasitic element 50 is used. In this way, even in a case where two parasitic elements 50 are used, the same effect as obtained from a diversity antenna is heightened further. Therefore, unlike in a case where diversity antennas and complicated circuits for controlling them are used for the purpose of avoiding a dead zone resulting from the direction of the linearly polarized wave of the antennas that transmit and receive a linearly polarized wave, substantially all directions can be covered by a single antenna. Accordingly, the antenna-switching function of a transceiver circuit is not required, and a stabilized performance can be maintained for all directions with a simple structure. In addition, the L-shaped parasitic element 50 can be accommodated in the touch sensor panel 10.

Even in a case where two parasitic elements 50 are used, the sum of the length m₁ of the long side 52 and the length m₂ of the short side 54 of the parasitic elements 50 is a length corresponding to a ½ wavelength resonates at the frequency of the linearly polarized wave that the antenna 16 transmits and receives. Furthermore, by changing the ratio of m₁/m₂ between the length m₁ of the long side 52 and the length in, of the short side 54 of the parasitic elements 50, it is possible to adjust the intensity of two linearly polarized waves orthogonal to each other that are transmitted from the entirety of the antenna 16 and two parasitic elements 50.

In addition, according to the distance between the antenna 16 and two parasitic elements 50 and the distance between two parasitic elements, it is possible to adjust the intensity and the phase of two linearly polarized waves orthogonal to each other that are transmitted from the entirety of the antenna 16 and two parasitic elements 50. A polarized wave obtained by synthesizing two linearly polarized waves orthogonal to each other becomes a new linearly polarized wave different from the linearly polarized wave of the antenna 16, an elliptically polarized wave, or a mixed polarized wave of a new linearly polarized wave different from the linearly polarized wave of the antenna 16 and an elliptically polarized wave.

Two parasitic elements 50 are provided on the same surface such as the front surface 20a or the rear surface 20b of the substrate 20. As shown in FIG. 12, two parasitic elements 50 may be provided on the front surface 20a of the substrate 20. Furthermore, a constitution may be adopted in which two parasitic elements 50 are provided on the rear surface 20b of the substrate 20, although the constitution is not shown in the drawing. In a case where a plurality of substrates are used, a constitution may be adopted in which one parasitic element 50 is provided on each substrate.

As shown in FIG. 13, a constitution may be adopted in which one parasitic element 50 is provided on the front surface 20a and the rear surface 20b of the substrate 20. In this case, the long side 52 is also disposed aligned along the straight line C.

In a case where the antenna 16 is, for example, a wideband antenna that can receive two different frequencies, two L-shaped parasitic elements form a set, and two sets of the parasitic elements are provided.

In this case, as shown in FIG. 14, a set 60a of first parasitic elements 50a is provided on the front surface 20a of the substrate 20, and a set 60b of second parasitic elements 50b is provided on the rear surface 20b of the substrate 20. In the set 60a, the first parasitic elements 50a are rotationally symmetrically disposed such that the long side 52a thereof is on the straight line C₁. In the set 60b, two second parasitic elements 50b are rotationally symmetrically disposed such that the long side 52b thereof is on a straight line C₂.

The frequency of the linearly polarized wave corresponding to each of the sets 60a and 60b is different for each of the sets 60a and 60b. The length of each of the long side 52a and the short side 54a of the first parasitic element 50a and the length of each of the long side 52b and the short side 54b of the second parasitic element 50b are preset according to the frequency of the linearly polarized wave received.

As long as each of the sets 60a and 60b is disposed on different surface of the substrate 20, each of the sets 60a and 60b may be provided on either the front surface 20a or the rear surface 20b without particular limitation.

The parasitic element 50 of each of the sets 60a and 60b, the sensor portion 18a, and the peripheral wiring portion 18b do not have to be formed of the same material, and can be formed of different materials with different thicknesses.

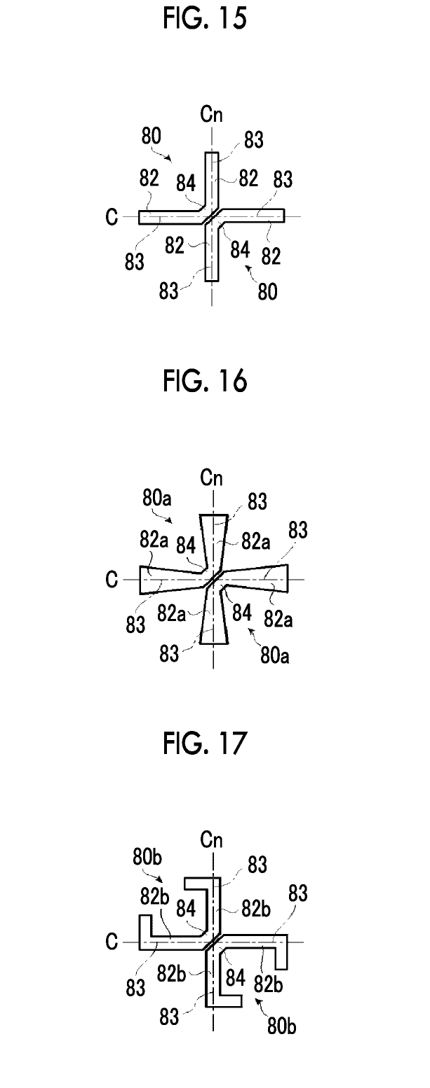

In a case where two L-shaped parasitic elements are formed on the same surface, in order to accomplish broadband communication and compactification, for example, it is also effective to adopt the shape shown in FIGS. 15 to 21. Herein, the parasitic elements for accomplishing broadband communication and compactification are not limited to the constitution shown in FIGS. 16 and 17. FIGS. 15 to 18 are schematic plan views showing an example of the disposition of two parasitic elements on the same surface.

In a parasitic element 80 shown in FIG. 15, two sides 82 disposed in a state where central axes 83 are orthogonal to each other are connected to each other through an oblique side 84 oblique to each of the central axes 83. The sides 82 have a constant width. In a state where the oblique sides 84 face each other, two parasitic elements 80 are disposed such that the central axes 83 of the sides 82 coincide with the straight line C and a straight line Cn orthogonal to the straight line C.

A parasitic element 80a shown in FIG. 16 has the same constitution as the parasitic element 80 shown in FIG. 15, except that, unlike in the parasitic element 80 shown in FIG. 15, the width of two sides 82a increases toward the distal end from the oblique side 84. Therefore, detailed description of the constitution of the parasitic element 80a will not be repeated. In a state where the oblique sides 84 face each other, the parasitic elements 80a are disposed such that the central axes 83 of the sides 82a coincide with the straight line C and the straight line Cn orthogonal to the straight line C. Because of being constituted with the wide sides 82a, the parasitic element 80a shown in FIG. 16 is effective for accomplishing broadband communication.

A parasitic element 80b shown in FIG. 17 has the same constitution as the parasitic element 80 shown in FIG. 15, except that, unlike in the parasitic element 80 shown in FIG. 15, two sides 82b of the parasitic element 80b has an L-shape. Therefore, the detailed description of the constitution of the parasitic element 80b will not be repeated. In a state where the oblique sides 84 face each other, two parasitic elements 80b are disposed such that the central axes 83 of the sides 82b coincide with the straight line C and the straight line Cn orthogonal to the straight line C. Because the side 82b has an L-shape, the parasitic element 80b shown in FIG. 17 is effective for compactification.

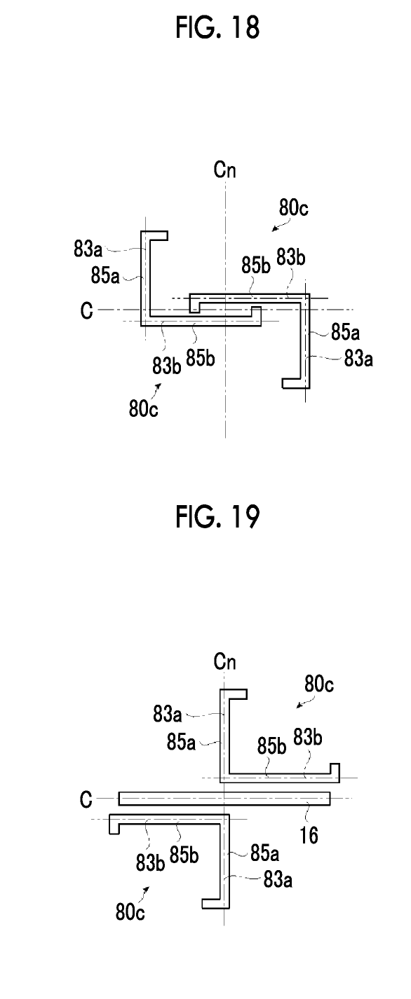

A parasitic element 80c shown in FIG. 18 has the same constitution as the parasitic element 80 shown in FIG. 15, except that, unlike in the parasitic element 80 shown in FIG. 15, first side 85a having an L-shape and a second side 85b having an L-shape are connected to each other at right angle, and two parasitic elements 80c are disposed across the straight line C in a state where the second sides 85b partially overlap each other. Therefore, the detailed description of the constitution of the parasitic element 80c will not be repeated. Two parasitic elements 80c are disposed in a state where the central axes 83b of the second sides 85b are parallel to the straight line C. In this case, a central axis 83a of the first side 85a is parallel to the straight line Cn orthogonal to the straight line C.

The parasitic elements 80c shown in FIG. 18 each have the first side 85a and the second side 85b having an L shape and are disposed in a state where the second sides 85b overlap with each other. Therefore, the parasitic elements 80c are effective for compactification.

FIG. 19 shows an example of the disposition of the parasitic elements 80c shown in FIG. 18 and the antenna 16.

As shown in FIG. 19, the antenna 16 is disposed along the straight line C. The straight line C corresponds to the plane of a linearly polarized wave during transmission and reception.

Two parasitic elements 80c are disposed across the antenna 16, in a state where the central axes 83b of the second sides 85b are parallel to the straight line C and the central axes 83a of the first sides 85a coincide with the straight line Cn. The straight line Cn is an axis perpendicular to the plane of a linearly polarized wave of the aforementioned antenna 16.

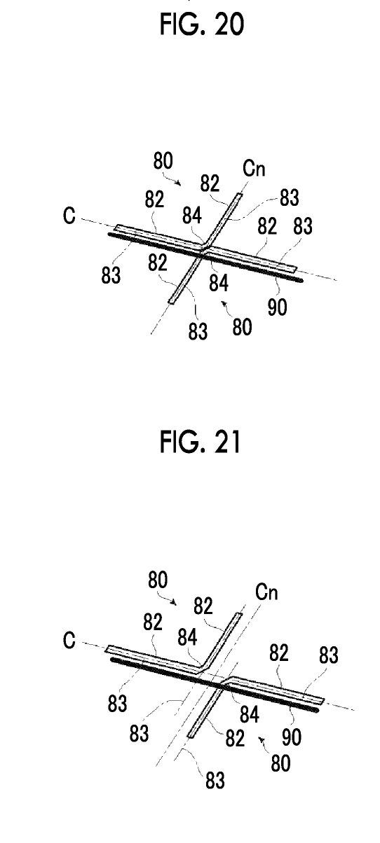

FIG. 20 shows an example of the disposition of the parasitic elements 80 shown in FIG. 15 and a dipole antenna 90. As shown in FIG. 20, the dipole antenna 90 is disposed along the straight line C. The straight line C corresponds to the plane of a linearly polarized wave during transmission and reception performed by the dipole antenna 90.

Two parasitic elements 80 are disposed with respect to the dipole antenna 90 in a state where the oblique sides 84 face each other and the central axes 83 of the sides 82 coincide with the straight line C and the straight line Cn orthogonal to the straight line C. The straight line Cn is an axis perpendicular to the aforementioned plane of a linearly polarized wave as well.

FIG. 21 shows another example of the disposition of the parasitic elements 80 shown in FIG. 15 and the dipole antenna 90. The disposition of two parasitic elements 80 and the dipole antenna 90 shown in FIG. 21 is the same as the disposition of two parasitic elements 80 shown in FIG. 20, except that, unlike in the disposition of two parasitic elements 80 and the dipole antenna 90 shown in FIG. 20, the parasitic elements are disposed in a state where the oblique sides 84 are separated from each other on the straight line C. Therefore, the detailed description of the disposition shown in FIG. 21 will not be repeated.

For the purpose of simplifying the manufacturing process and reducing the manufacturing costs, it is desirable that two parasitic elements 50 are formed on the touch sensor panel 10. In contrast, in a mobile terminal apparatus that does not have a touch sensor function, for the substrate having two parasitic elements 50, it is not necessary to consider the simplification of the manufacturing process and the reduction of the manufacturing costs. In this case, two parasitic elements 50 may be prepared not on the substrate 20 of the touch sensor panel 10 but on another general-purpose flexible substrate 92 (see FIG. 1). Hereinafter, the flexible substrate 92 will be simply referred to as a substrate 92. The substrate 92 is not limited to a flexible substrate.

The substrate 92 is disposed near the antenna 16 (see FIG. 1) transmitting and receiving a linearly polarized wave. For example, the substrate 92 is disposed in a position that is between the display device 13 (see FIG. 1) and a cover layer such as tempered glass provided on the display device 13. The substrate 92 having two parasitic elements 50 can be provided with the adhesive layer 22 (see FIG. 3) and, if necessary, the protective layer 24 (see FIG. 3).

The substrate 92 having two parasitic elements 50 may be disposed on the side opposite to the display device 13, that is, the rear surface side of the mobile terminal apparatus 17 (see FIG. 1). For example, the substrate 92 can be disposed on the inner surface of a rear surface cover formed of a nonconductive material.

The antenna 16 can be disposed on the front surface 11a of the main substrate 11, and two parasitic elements 50 can be disposed on a rear surface 11b of the main substrate 11. The antenna 16 does not have to be disposed on the front surface 11a of the main substrate 11. For example, the antenna 16 may be a flexible planar antenna formed on a polyimide substrate and connected to the main substrate 11 through a cable.

Next, a third embodiment of the touch sensor panel will be described.

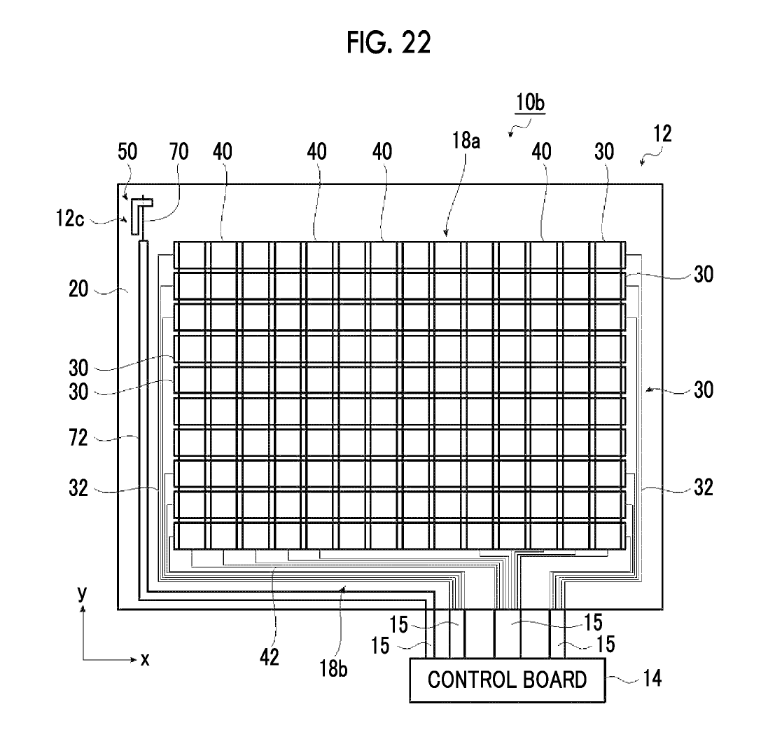

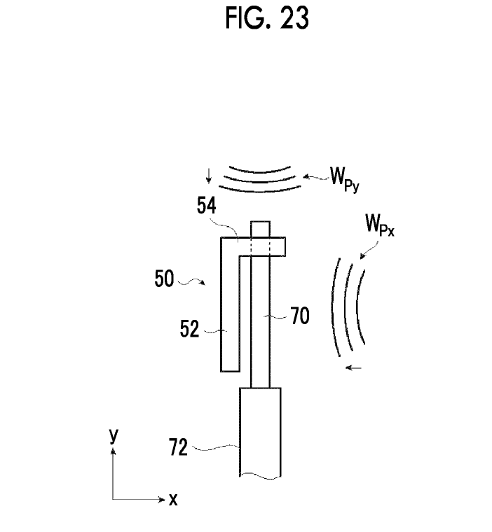

FIG. 22 is a schematic plan view showing a touch sensor panel of the third embodiment of the present invention. FIG. 23 is a schematic plan view showing an example of the disposition of parasitic elements.

In FIGS. 22 and 23, the same constituents as the touch sensor panel 10 of the first embodiment shown in FIGS. 1 and 2, the touch sensor portion 12 of the first embodiment shown in FIGS. 3 to 5, and the parasitic element 50 of the first embodiment shown in FIGS. 6 and 7 are marked with the same references, and the detailed description thereof will not be repeated. In FIG. 22, for some of the first conductive layers 30, the first wiring 32 connected thereto is not shown. Furthermore, for some of the second conductive layers 40, the second wiring 42 connected thereto is not shown in the drawing.

A touch sensor panel 10b of the present embodiment shown in FIG. 22 has the same constitution as the touch sensor panel 10 (see FIG. 2) of the first embodiment, except that the constitution of the antenna 70 and the disposition position of the parasitic element 50 are different from those in the touch sensor panel 10 (see FIG. 2) of the first embodiment. Therefore, the detailed description of the constitution of the touch sensor panel 10b will not be repeated.

In the touch sensor panel 10b, the antenna 70 is provided in the corner portion 12c of the touch sensor portion 12. The antenna 70 is a kind of monopole antenna, in which the portion overlapping with the ground wire 72 has a microstrip line structure. Each of the antenna 70 and the ground wire 72 is connected to the flexible printed circuits 15 and electrically connected to a signal wire (not shown in the drawing) and a ground wire (not shown in the drawing) of the main substrate 11. The antenna 70 and the ground wire 72 may be constituted with either the foil-like conductor 56 shown in FIG. 6 similarly to the parasitic element 50 or the mesh-like conductor 58 shown in FIG. 7.

As shown in FIG. 23, for example, the receiving sensitivity of the antenna 70 with respect to the linearly polarized wave Wpx in the y-axis direction is relatively higher than the receiving sensitivity of the antenna 70 with respect to the linearly polarized wave Wpy in the x-axis direction. In this case, in order to improve the receiving sensitivity with respect to the linearly polarized wave Wpy in the x-axis direction, the parasitic element 50 is disposed such that the short side 54 is in the x-axis direction and that the long side 52 extends along the antenna 70 that runs in the y-axis direction. Even in this case, the parasitic element 50 is in a floating state and is not connected to any member including the antenna 70 through a conductor or the like. However, the parasitic element 50 interacts with and is electrically bonded to the antenna 70. The parasitic element 50 and the antenna 70 functions as a single integrated antenna, that is, an antenna for both the linearly polarized wave and the cross-polarized wave.

In a case where the linearly polarized wave Wpy in the x-axis direction reaches the parasitic element 50 by disposing the parasitic element 50 as described above with respect to the antenna 70 which is a monopole antenna, an induced current occurs along the x-axis direction and spreads over the entirety of the parasitic element 50. Due to the induced current, the linearly polarized wave is retransmitted from the long side 52 as the linearly polarized wave Wpx in the y-axis direction and is received by the antenna 70. In this way, the receiving sensitivity of the antenna 70 with respect to the linearly polarized wave Wpy in the x-axis direction can be enhanced, and the communication performance with respect to the linearly polarized wave orthogonal to the plane of a linearly polarized wave of the antenna 70 can be improved. In a case where the linearly polarized wave is transmitted from the antenna 70, due to the linearly polarized wave Wpx in the y-axis direction, the parasitic element 50 resonates. As a result, an induced current occurs in the long side 52 along the y-axis direction, and the linearly polarized wave Wpy in the x-axis direction is transmitted from the short side 54. With the combination of the antenna 70 and the parasitic element 50, it is also possible to obtain the same effect as obtained from the aforementioned combination of the antenna 16 and the parasitic element 50.

Herein, although one parasitic element 50 is disposed on the antenna 70, the present invention is not limited thereto, and two parasitic elements 50 may be provided.

Regarding the antenna 70, the ground wire 72, and the parasitic element 50, for example, the antenna 70 is disposed on the front surface 20a of the substrate 20, and the ground wire 72 and the parasitic element 50 are disposed on the rear surface 20b. Accordingly, the antenna 70, the ground wire 72, and the parasitic element 50 can be collectively formed together with the first conductive layer 30, the second conductive layer 40, the first wiring 32, or the second wiring 42. As a result, the manufacturing process can be simplified, and the manufacturing costs can be reduced. Furthermore, the aforementioned members can be formed of the same material, and can have the same thickness. It goes without saying that the antenna 70, the ground wire 72, the parasitic element 50, the sensor portion 18a, and the peripheral wiring portion 18b do not have to be formed of the same material. These may be formed of different materials at different thicknesses.

For the purpose of simplifying the manufacturing process and reducing the manufacturing costs, the antenna 70, the ground wire 72, and the parasitic element 50 are formed on the touch sensor panel 10. In contrast, in a mobile terminal apparatus that does not have a touch sensor function, for the substrate having the antenna 70, the ground wire 72, and the parasitic element 50, it is not necessary to consider the simplification of the manufacturing process and the reduction of the manufacturing costs. In this case, the antenna 70, the ground wire 72, and the parasitic element 50 may be prepared not on the substrate 20 of the touch sensor panel 10 but on the aforementioned substrate 92 (see FIG. 1).

The substrate 92 is disposed in a position that is between the display device 13 (see FIG. 1) and a cover layer such as tempered glass provided on the display device 13, for example. The substrate 92 having the antenna 70, the ground wire 72, and the parasitic element 50 can be provided with the adhesive layer 22 (see FIG. 3) and, if necessary, the protective layer 24 (see FIG. 3).

The substrate 92 having the antenna 70, the ground wire 72, and the parasitic element 50 can be disposed on the side opposite to the display device 13, that is, the rear surface side of the mobile terminal apparatus 17 (see FIG. 1). For example, the substrate 92 can be disposed on the inner surface of a rear surface cover formed of a nonconductive material.

The antenna 16 does not have to be installed on the main substrate 11. As long as the antenna 16 and the parasitic element 50 are close to each other, and the specific positional relationship shown in FIGS. 1, 2, 8, 9, 10, and 11 is satisfied, the antenna 16 can also be provided on other general-purpose substrates (not shown in the drawing) such as a glass epoxy substrate and a polyimide substrate.

The state where the antenna 16 and the parasitic element 50 are close to each other means that an interval between the central axis of the linearly polarized wave of the antenna 16 and the central axis of one side of the parasitic element 50 in the z-axis direction (not shown in the drawing) is narrow. The interval between the central axis of the linearly polarized wave of the antenna 16 and the central axis of one side of the parasitic element 50 in the z-axis direction (not shown in the drawing) is determined by the distance between the main substrate 11 or a general-purpose substrate (not shown in the drawing) on which the antenna 16 is provided and the touch sensor portion 12 on which the parasitic element 50 is provided, the thickness of the substrate 20, the thickness of the adhesive layer 22, the thickness of the protective layer 24, and the height of the antenna 16. The acceptable interval between the central axis of the linearly polarized wave of the antenna 16 and the central axis of one side of the parasitic element 50 in the z-axis direction is within a range of 0 mm to 100 mm, desirably 0 mm to 20 mm, and most desirably 0 mm to 10 mm.

An interval of 0 mm in the z direction means that the antenna 16 and the parasitic element 50 are formed on the same surface.

As described above, as long as the antenna 16 and the parasitic element 50 are close to each other, and the specific positional relationship between the antenna 16 and the parasitic element 50 is satisfied, the antenna 16 and the parasitic element 50 function as a single integrated antenna.

Hereinafter, the method for manufacturing a touch sensor panel will be described.

In the above section, touch sensor panels were described using various examples. Hereinbelow, as a typical example, the touch sensor panel 10 shown in FIG. 2 will be described. As described above, in the touch sensor panel 10, the L-shaped parasitic element 50 is formed on the same surface as the second conductive layer 40 and the second wiring 42. In a case where the second conductive layer 40 and the second wiring 42 are formed on the front surface 20a of the substrate 20, the L-shaped parasitic element 50 can also be formed together through the same step by using the same material such as copper. Therefore, the method for manufacturing the touch sensor panel 10 that will be described below can also be applied to the method for manufacturing the parasitic element 50.

As the method for manufacturing the touch sensor panel 10, for example, a photosensitive layer to be plated may be formed on the substrate 20 by using a pretreatment material for plating, and then exposure and a development treatment may be performed, followed by a plating treatment. By forming a metal portion and a light-transmitting portion in an exposed portion and an unexposed portion in the manner described above, the first conductive layer 30, the first wiring 32, the second conductive layer 40, and the second wiring 42 may be formed. Herein, by additionally performing at least any one of physical development and a plating treatment on the metal portion, a conductive metal may be supported on the metal portion.

As more preferred aspects of the method using the pretreatment material for plating, the following two aspects can be exemplified. The following aspects are more specifically described in JP2003-213437A, JP2006-64923A, JP2006-58797A, JP2006-135271A, and the like.

(a) Aspect in which the substrate 20 is coated with a layer to be plated containing a functional group interacting with a plating catalyst or a precursor thereof, followed by exposure and development, and then a plating treatment is performed such that a metal portion is formed on a material to be plated.

(b) Aspect in which an undercoat layer containing a polymer and a metal oxide and a layer to be plated containing a functional group interacting with a plating catalyst or a precursor thereof are laminated in this order on the substrate 20, followed by exposure or development, and then a plating treatment is performed such that a metal portion is formed on a material to be plated.

Alternatively, by performing exposure on a photosensitive material, in which an emulsion layer containing a photosensitive silver halide salt is on the substrate 20, and performing a development treatment such that a metal portion and a light-transmitting portion are formed in an exposed portion and an unexposed portion, the first conductive layer 30, the first wiring 32, the second conductive layer 40, and the second wiring 42 may be formed. Herein, by additionally performing at least any one of physical development and a plating treatment on the metal portion, a conductive metal may be supported on the metal portion.

As another method, by performing exposure and a development treatment on a photoresist film on a metal foil formed on the substrate 20 so as to form a resist pattern and etching the metal foil exposed from the resist pattern, the first conductive layer 30, the first wiring 32, the second conductive layer 40 and the second wiring 42 may be formed.

Alternatively, by printing a paste containing metal fine particles on the substrate 20 and performing metal plating on the paste, a mesh pattern may be formed.

Otherwise, on the substrate 20, a mesh pattern may be formed by printing by using a screen printing plate or a gravure printing plate.

As another option, on the substrate 20, the first conductive layer 30, the first wiring 32, the second conductive layer 40, and the second wiring 42 may be formed by using an ink jet.

Or, a resin layer formed on a film, a mold on which an embossing pattern is formed is pressed on the resin layer such that an intaglio pattern is formed on the resin layer, and then the entire surface of the resin layer including the intaglio pattern is coated with an electrode material. Thereafter, by removing the electrode material on the surface of the resin layer, a mesh pattern may be formed which is composed of the electrode material that fills the intaglio pattern of the resin layer.

Next, a method using a plating method that is a particularly preferred aspect of the touch sensor panel 10 will be mainly described.

The method for manufacturing the touch sensor panel 10 includes a step (step 1) of forming a pattern-like layer to be plated on a substrate, and a step (step 2) of forming a pattern-like metal layer on the pattern-like layer to be plated.

Hereinafter, the members and materials used in each of the steps and the procedure of the steps will be specifically described.

[Step 1: Step of Forming Pattern-Like Layer to be Plated]

Step 1 is a step of forming a pattern-like layer to be plated on a substrate by pattern-wise applying energy to a composition for forming a layer to be plated containing a compound which has a functional group interacting with a metal ion (hereinafter, referred to as “interactive group” as well) and a polymerizable group. More specifically, step 1 is a step in which, first, a coating film of the composition for forming a layer to be plated is formed on the substrate 20, energy is pattern-wise applied to the obtained coating film such that the reaction of the polymerizable group is accelerated and curing occurs, and then a region to which the energy is not applied is removed, thereby obtaining a pattern-like layer to be plated.

According to the function of the interactive group, in step 2 which will be described later, a metal ion is adsorbed onto (adheres to) the pattern-like layer to be plated formed through the aforementioned step. That is, the pattern-like layer to be plated functions as an excellent metal ion-accepting layer. Furthermore, due to the curing treatment by the application of energy, the polymerizable group is used for bonding between compounds, and as a result, it is possible to obtain a pattern-like layer to be plated having excellent hardness.

Hereinafter, first, the members and materials used in step 1 will be specifically described, and then the procedure of the step will be specifically described.

(Substrate)

The substrate 20 has two main surfaces and is constituted with, for example, a flexible transparent substrate, and is formed of an electrical insulating material because a conductive layer and the like are formed thereon. For example, it is possible to use flexible substrates such as a plastic film and a plastic plate. The plastic film and the plastic plate can be constituted with polyesters such as polyethylene terephthalate (PET) and polyethylene naphthalate (PEN), polyolefins such as polyethylene (PE), polypropylene (PP), polystyrene, ethylene vinyl acetate (EVA), a cycloolefin polymer (COP), and a cycloolefin copolymer (COC), a vinyl-based resin, polycarbonate (PC), polyamide, polyimide, an acrylic resin, triacetyl cellulose (TAC), polytetrafluoroethylene (PTFE), and the like. From the viewpoint of light transmitting properties, thermal contractility, workability, and the like, it is preferable that the substrate is constituted with polyolefins such as polyethylene terephthalate (PET), a cycloolefin polymer (COP), and a cycloolefin copolymer (COC).

As the substrate 20, it is also possible to use a treated support having undergone at least one treatment among an atmospheric plasma treatment, a corona discharge treatment, and an ultraviolet irradiation treatment. By performing the aforementioned treatments, a hydrophilic group such as a OH group is introduced into the surface of the treated support, and hence the adhesiveness of the first conductive layer 30, the first wiring 32, the second conductive layer 40, and the second wiring 42 is further improved. Among the aforementioned treatments, in view of further improving the adhesiveness of the first conductive layer 30, the first wiring 32, the second conductive layer 40, and the second wiring 42, the atmospheric plasma treatment is preferable.

The thickness of the substrate 20 is preferably 5 to 350 μm, and more preferably 30 to 150 μm. In a case where the thickness of the substrate 20 is within a range of 5 to 350 μm, a visible light transmittance is obtained as described above. That is, the substrate becomes transparent and is easily handled.

(Composition for Forming Layer to be Plated)

The composition for forming a layer to be plated contains a compound which has a functional group interacting with a metal ion and a polymerizable group.

The functional group interacting with a metal ion means a functional group interacting with a metal ion applied to the pattern-like layer to be plated in a step which will be described later. As the functional group, for example, it is possible to use a functional group which can have an electrostatic interaction with a metal ion or a nitrogen-containing functional group, a sulfur-containing functional group, an oxygen-containing functional group and the like which can be coordinated to a metal ion.

More specific examples of the interactive group include nitrogen-containing functional groups such as an amino group, an amide group, an imide group, a urea group, a tertiary amino group, an ammonium group, an amidino group, a triazine ring, a triazole ring, a benzotriazole group, an imidazole group, an benzimidazole group, a quinoline group, a pyridine group, a pyrimidine group, a pyrazine group, a quinazoline group, a quinoxaline group, a purine group, a triazine group, a piperidine group, a piperazine group, a pyrrolidine group, a pyrazole group, an aniline group, a group having an alkylamine structure, a group having an isocyanuric structure, a nitro group, a nitroso group, an azo group, a diazo group, an azide group, a cyano group, and a cyanate group (R—O—CN); oxygen-containing functional groups such as an ether group, a hydroxyl group, a phenolic hydroxyl group, a carboxyl group, a carbonate group, a carbonyl group, an ester group, a group having a N-oxide structure, a group having a S-oxide structure, and a group having a N-hydroxy structure; sulfur-containing functional groups such as a thiophene group, a thiol group, a thiourea group, a thiocyanuric acid group, a benzothiazole group, a mercaptotriazine group, a thioether group, a thioxy group, a sulfoxide group, a sulfone group, a sulfite group, a group having a sulfoximine structure, a group having a sulfoxinium salt structure, a sulfonic acid group, and a group having a sulfonic acid ester structure; phosphorus-containing functional groups such as a phosphate group, a phosphoramide group, a phosphine group, and a group having a phosphoric acid ester structure; groups having a halogen atom such as chlorine and bromine; and the like. Moreover, salts of the functional groups that can form a salt structure can be used.

Among these, an ionic polar group such as a carboxyl group, a sulfonic acid group, a phosphoric acid group, or a boronic acid group, an ether group, or a cyano group is particularly preferable because these exhibit high polarity and can be excellently adsorbed onto a metal ion and the like, and a carboxyl group or a cyano group is more preferable.

The compound may contain two or more kinds of interactive groups. The number of interactive groups contained in the compound is not particularly limited, and may be 1 or 2 or greater.

The polymerizable group is a functional group that can form a chemical bond by the application of energy, and examples thereof include a radically polymerizable group, a cationically polymerizable group, and the like. Among these, from the viewpoint of better reactivity, a radically polymerizable group is preferable. Examples of the radically polymerizable group include an unsaturated carboxylic acid ester group such as an acrylic acid ester group (acryloyloxy group), a methacrylic acid ester group (methacryloyloxy group), an itaconic acid ester group, a crotonic acid ester group, an isocrotonic acid ester group, or a maleic acid ester group, a styryl group, a vinyl group, an acrylamide group, a methacrylamide group, and the like. Among these, a methacryloyloxy group, an acryloyloxy group, a vinyl group, a styryl group, an acrylamide group, and a methacrylamide group are preferable, and a methacryloyloxy group, an acryloyloxy group, and a styryl group are particularly preferable.

The compound may contain two or more kinds of polymerizable groups. The number of polymerizable groups contained in the compound is not particularly limited, and may be 1 or 2 or greater.

The aforementioned compound may be a low-molecular weight compound or a high-molecular weight compound. The low-molecular weight compound means a compound having a molecular weight of less than 1,000, and the high-molecular weight compound means a compound having a molecular weight of equal to or greater than 1,000.

The low-molecular weight compound having the aforementioned polymerizable group corresponds to a so-called monomer. Furthermore, the high-molecular weight compound may be a polymer having a predetermined repeating unit.

One kind of compound may be used singly, or two or more kinds thereof may be used in combination.

In a case where the aforementioned compound is a polymer, the mass average molecular weight of the polymer is not particularly limited. The mass average molecular weight of the polymer is preferably equal to or greater than 1,000 and equal to or smaller than 700,000, and more preferably equal to or greater than 2,000 and equal to or smaller than 200,000, because then the handleability such as solubility is further improved. Particularly, from the viewpoint of polymerization sensitivity, the mass average molecular weight of the polymer is preferably equal to or greater than 20,000.

The method for synthesizing the aforementioned polymer having a polymerizable group and an interactive group is not particularly limited, and known synthesis methods (see paragraphs “0097” to “0125” in JP2009-280905A) can be used.

(Suitable Aspect 1 of Polymer)

As a first preferred aspect of the polymer, a copolymer can be exemplified which contains a repeating unit (hereinafter, referred to as a polymerizable group unit as appropriate) having a polymerizable group represented by Formula (a) and a repeating unit (hereinafter, referred to as an interactive group unit as appropriate) having an interactive group represented by Formula (b).

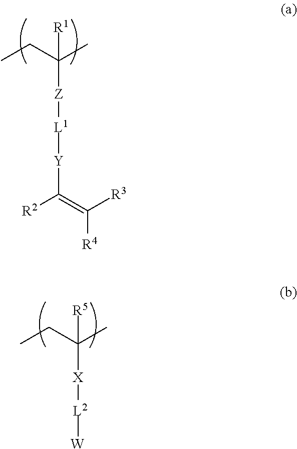

In Formulae (a) and (b), R¹ to R⁵ each independently represent a hydrogen atom or a substituted or unsubstituted alkyl group (for example, a methyl group, an ethyl group, a propyl group, a butyl group, or the like). The type of the substituent is not particularly limited, but examples thereof include a methoxy group, a chlorine atom, a bromine atom, a fluorine atom, and the like.

R¹ is preferably a hydrogen atom, a methyl group, or a methyl group substituted with a bromine atom. R² is preferably a hydrogen atom, a methyl group, or a methyl group substituted with a bromine atom. R³ is preferably a hydrogen atom. R⁴ is preferably a hydrogen atom. R⁵ is preferably a hydrogen atom, a methyl group, or a methyl group substituted with a bromine atom.

In Formulae (a) and (b), X, Y, and Z each independently represent a single bond or a substituted or unsubstituted divalent organic group. Examples of the divalent organic group include a substituted or unsubstituted divalent aliphatic hydrocarbon group (preferably having 1 to 8 carbon atoms, for example, an alkylene group such as a methylene group, an ethylene group, or a propylene group), a substituted or unsubstituted divalent aromatic hydrocarbon group (preferably having 6 to 12 carbon atoms, for example, a phenylene group), —O—, —S—, —SO₂—, —N(R)— (R: alkyl group), —CO—, —NH—, —COO—, —CONH—, a group obtained by combining these (for example, an alkyleneoxy group, an alkyleneoxycarbonyl group, and an alkylenecarbonyloxy group), and the like.

Each of X, Y, and Z is preferably a single bond, an ester group (—COO—), an amide group (—CONH—), an ether group (—O—), or a substituted or unsubstituted divalent aromatic hydrocarbon group, and more preferably a single bond, an ester group (—COO—), or an amide group (—CONH—), because then the polymer is easily synthesized, and the adhesiveness of the pattern-like metal layer is further improved.

In Formulae (a) and (b), L¹ and L² each independently represent a single bond or a substituted or unsubstituted divalent organic group. The divalent organic group has the same definition as the divalent organic group described above for X, Y, and Z.

L¹ is preferably an aliphatic hydrocarbon group or a divalent organic group (for example, an aliphatic hydrocarbon group) having a urethane bond or a urea bond, because then the polymer is easily synthesized, and the adhesiveness of the pattern-like metal layer is further improved. Particularly, L¹ preferably has 1 to 9 carbon atoms in total. The total number of carbon atoms in L¹ means the total number of carbon atoms contained in the substituted or unsubstituted divalent organic group represented by L¹.

L² is preferably a single bond or a divalent aliphatic hydrocarbon group, a divalent aromatic hydrocarbon group, or a group obtained by combining these, because then the adhesiveness of the pattern-like metal layer is further improved. Among these, a single bond or a group having 1 to 15 carbon atoms in total is preferred as L². L² is particularly preferably unsubstituted. The total number of carbon atoms in L² means the total number of carbon atoms contained in the substituted or unsubstituted divalent organic group represented by L².

In Formula (b), W represents an interactive group. The definition of the interactive group is as described above.

In view of the reactivity (curing properties and polymerization properties) and the inhibition of gelation at the time of synthesis, the content of the aforementioned polymerizable group unit with respect to all the repeating units in the polymer is preferably 5 to 50 mol %, and more preferably 5 to 40 mol %.

Furthermore, from the viewpoint of the adsorptivity with respect to a metal ion, the content of the aforementioned interactive group unit with respect to all the repeating units in the polymer is preferably 5 to 95 mol %, and more preferably 10 to 95 mol %.

(Suitable Aspect 2 of Polymer)

As a second preferred aspect of the polymer, a copolymer can be exemplified which contains repeating units represented by Formulae (A), (B), and (C).

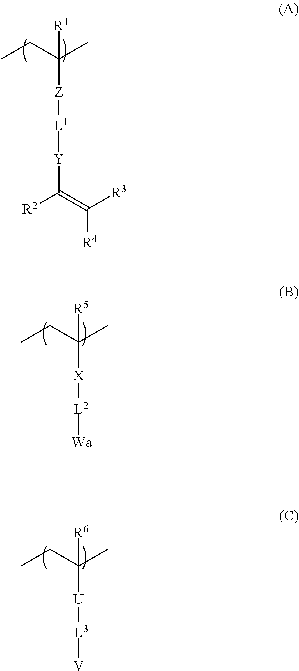

The repeating unit represented by Formula (A) is the same as the repeating unit represented by Formula (a), and the description of each group is also the same.

R⁵, X, and L² in the repeating unit represented by Formula (B) are the same as R⁵, X, and L² in the repeating unit represented by Formula (b), and the description of each group is also the same.

Wa in Formula (B) represents a group interacting with a metal ion, excluding a hydrophilic group represented by V which will be described later or a precursor group thereof. Wa is particularly preferably a cyano group or an ether group.

In Formula (C), R⁶ each independently represents a hydrogen atom or a substituted or unsubstituted alkyl group.

In Formula (C), U represents a single bond or a substituted or unsubstituted divalent organic group. The divalent organic group has the same definition as the divalent organic group represented by X, Y, and Z described above. U is preferably a single bond, an ester group (—COO—), an amide group (—CONH—), an ether group (—O—), or a substituted or unsubstituted divalent aromatic hydrocarbon group, because then the polymer is easily synthesized, and the adhesiveness of the pattern-like metal layer is further improved.

In Formula (C), L³ represents a single bond or a substituted or unsubstituted divalent organic group. The divalent organic group has the same definition as the divalent organic group represented by L¹ and L² described above. L³ is preferably a single bond, a divalent aliphatic hydrocarbon group, a divalent aromatic hydrocarbon group, or a group obtained by combining these, because then the polymer is easily synthesized, and the adhesiveness of the pattern-like metal layer is further improved.

In Formula (C), V represents a hydrophilic group or a precursor group thereof. The hydrophilic group is not particularly limited as long as it exhibits hydrophilicity, and examples thereof include a hydroxyl group, a carboxylic acid group, and the like. The precursor group of the hydrophilic group means a group generating a hydrophilic group by a predetermined treatment (for example, a treatment using an aid or an alkali), and examples thereof include a carboxyl group protected with a 2-tetrahydropyranyl (THP) group and the like.

In view of the interaction with a metal ion, the hydrophilic group is preferably an ionic polar group. Examples of the ionic polar group specifically include a carboxylic acid group, a sulfonic acid group, a phosphoric acid group, and a boronic acid group. Among these, a carboxylic acid group is preferable because it has appropriate acidity (it does not decompose other functional groups).

The preferred content of each unit in the second preferred aspect of the aforementioned polymer is as described below.

In view of the reactivity (curing properties and polymerization properties) and the inhibition of gelation at the time of synthesis, the content of the repeating unit represented by Formula (A) with respect to all the repeating units in the polymer is preferably 5 to 50 mol %, and more preferably 5 to 30 mol %.

From the viewpoint of the adsortivity with respect to a metal ion, the content of the repeating unit represented by Formula (B) with respect to all the repeating units in the polymer is preferably 5 to 75 mol %, and more preferably 10 to 70 mol %.

In view of the developability in an aqueous solution the moisture-resistant adhesiveness, the content of the repeating unit represented by Formula (C) with respect to all the repeating units in the polymer is preferably 10 to 70 mol %, more preferably 20 to 60 mol %, and even more preferably 30 to 50 mol %.

Specific examples of the aforementioned polymer include the polymers described in paragraphs “0106” to “0112” in JP2009-007540A, the polymers described in paragraphs “0065” to “0070” in JP2006-135271A, the polymers described in paragraphs “0030” to “0108” in US2010-080964, and the like.

These polymers can be manufactured by known methods (for example, the methods described in the documents exemplified above).

(Suitable Aspect of Monomer)

In a case where the aforementioned compound is a so-called monomer, as a suitable aspect thereof, a compound represented by Formula (X) can be exemplified.

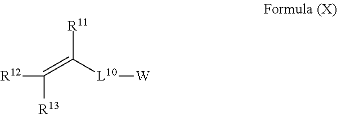

In Formula (X), R¹¹ to R¹³ each independently represent a hydrogen atom or a substituted or unsubstituted alkyl group. Examples of the unsubstituted alkyl group include a methyl group, an ethyl group, a propyl group, and a butyl group. Examples of the substituted alkyl group include a methyl group, an ethyl group, a propyl group, and a butyl group substituted with a methoxy group, a chlorine atom, a bromine atom, a fluorine atom, and the like. R¹¹ is preferably a hydrogen atom or a methyl group. R¹² is preferably a hydrogen atom. R¹³ is preferably a hydrogen atom.

L¹⁰ represents a single bond or a divalent organic group. Examples of the divalent organic group include a substituted or unsubstituted aliphatic hydrocarbon group (preferably having 1 to 8 carbon atoms), a substituted or unsubstituted aromatic hydrocarbon group (preferably having 6 to 12 carbon atoms), O, S, SO₂, —N(R)— (R: alkyl group), —CO—, —NH—, —COO—, —CONH—, a group obtained by combining these (for example, an alkyleneoxy group, an alkyleneoxycarbonyl group, and an alkylenecarbonyloxy group), and the like.

The substituted or unsubstituted aliphatic hydrocarbon group is preferably a methylene group, an ethylene group, a propylene group, a butylene group, or these groups substituted with a methoxy group, a chlorine atom, a bromine atom, a fluorine atom, or the like.

The substituted or unsubstituted aromatic hydrocarbon group is preferably an unsubstituted phenylene group or a phenylene group substituted with a methoxy group, a chlorine atom, a bromine atom, a fluorine atom, or the like.

As a suitable aspect of L¹⁰ in Formula (X), a —NH-aliphatic hydrocarbon group or a —CO-aliphatic hydrocarbon group can be exemplified.

W has the same definition as W in Formula (b), and represents an interactive group. The definition of the interactive group is as described above.

As a suitable aspect of W in Formula (X), an ionic polar group can be exemplified. W is more preferably a carboxylic acid group.

In a case where the aforementioned compound is a so-called monomer, as another suitable aspect, a compound represented by Formula (1) can be exemplified.

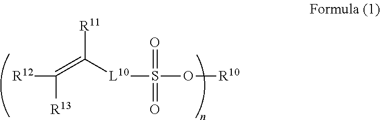

In Formula (1), R¹⁰ represents a hydrogen atom, a metal cation, or a quaternary ammonium cation. Examples of the metal cation include an alkali metal cation (a sodium ion or a calcium ion), a copper ion, a palladium ion, a silver ion, and the like. As the metal cation, a monovalent or divalent metal cation is mainly used. In a case where a divalent metal cation (for example, a palladium ion) is used, n which will be described later represents 2.

Examples of the quaternary ammonium cation include a tetramethyl ammonium ion, a tetrabutyl ammonium ion, and the like.

In view of the adherence of a metal ion and the metal residue after patterning, R¹⁰ is particularly preferably a hydrogen atom.

L¹⁰ in Formula (1) has the same definition as Formula (X) described above, and represents a single bond or a divalent organic group. The definition of the divalent organic group is as described above.

R¹¹ to R¹³ in Formula (1) have the same definition as R¹¹ to R¹³ in Formula (X) described above, and represent a hydrogen atom or a substituted or unsubstituted alkyl group. The suitable aspects of R¹¹ to R¹³ are as described above.

n represents an integer of 1 or 2. From the viewpoint of the availability of the compound, n is particularly preferably 1.

As a suitable aspect of the compound represented by Formula (1), a compound represented by Formula (2) can be exemplified.

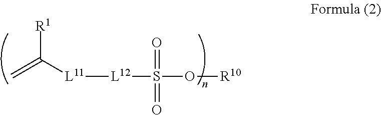

In Formula (2), R¹⁰, R¹¹, and n have the same definition as described above. L represents an ester group (—COO—), an amide group (—CONH—), or a phenylene group. Particularly, in a case where L¹¹ is an amide group, the polymerization properties and the solvent resistance (for example, alkaline solvent resistance) of the obtained layer to be plated are improved.

L¹² represents a single bond, a divalent aliphatic hydrocarbon group (preferably having 1 to 8 carbon atoms and more preferably having 3 to 5 carbon atoms), or a divalent aromatic hydrocarbon group. The aliphatic hydrocarbon group may be linear, branched, or cyclic. In a case where L¹² is a single bond, L¹¹ represents a phenylene group.

The molecular weight of the compound represented by Formula (1) is not particularly limited. From the viewpoint of the volatility, the solubility in a solvent, the film forming properties, handleability, and the like, the molecular weight of the compound is preferably 100 to 1,000, and more preferably 100 to 300.

The content of the aforementioned compound in the composition for forming a layer to be plated is not particularly limited, but is preferably 2% to 50% by mass and more preferably 5% to 30% by mass with respect to the total amount of the composition. In a case where the content of the compound is within the above range, the handleability of the composition becomes excellent, and the thickness of the pattern-like layer to be plated is easily controlled.

In view of handleability, it is preferable that the composition for forming a layer to be plated contains a solvent.

The usable solvent is not particularly limited, and examples thereof include water; alcohol-based solvents such as methanol, ethanol, propanol, ethylene glycol, 1-methoxy-2-propanol, glycerine, and propylene glycol monomethyl ether; acids such as acetic acid; ketone-based solvents such as acetone, methyl ethyl ketone, and cyclohexanone; amide-based solvents such as formamide, dimethyl acetamide, and N-methylpyrrolidone; nitrile-based solvents such as acetonitrile and propionitrile; ester-bases solvents such as methyl acetate and ethyl acetate; carbonate-based solvents such as dimethyl carbonate and diethyl carbonate; ether-based solvents, glycol-based solvents, amine-based solvents, thiol-based solvents, halogen-based solvents, and the like.

Among these, alcohol-based solvents, amide-based solvents, ketone-based solvents, nitrile-based solvents, and carbonate-based solvents are preferable.

The content of the solvent in the composition for forming a layer to be plated is not particularly limited, but is preferably 50% to 98% by mass and more preferably 70% to 95% by mass with respect to the total amount of the composition. In a case where the content of the solvent is within the above range, the handleability of the composition becomes excellent, and the thickness of the pattern-like layer to be plated is easily controlled.

The composition for forming a layer to be plated may contain a polymerization initiator. In a case where the composition contains a polymerization initiator, the bond between compounds and between a compound and the substrate formed more, and consequently, it is possible to obtain a pattern-like metal layer having better adhesiveness.

The polymerization initiator to be used is not particularly limited, and for example, a thermal polymerization initiator, a photopolymerization initiator, and the like can be used. Examples of the photopolymerization initiator include benzophenones, acetophenones, α-aminoalkylphenones, benzoins, ketones, thioxanthones, benzyls, benzylketals, oxime esters, anthrones, tetramethylthiuram monosulfides, bisacylphosphine oxides, acylphosphine oxides, anthraquinones, azo compounds, and derivatives of these.

Examples of the thermal polymerization initiator include diazo-based compounds, peroxide-based compounds, and the like.

In a case where the composition for forming a layer to be plated contains a polymerization initiator, the content of the polymerization initiator with respect to the total amount of the composition is preferably 0.01% to 1% by mass, and more preferably 0.1% to 0.5% by mass. In a case where the content of the polymerization initiator is within the above range, the handleability of the composition becomes excellent, and the adhesiveness of the obtained pattern-like metal layer is further improved.

The composition for forming a layer to be plated may contain a monomer (here, the compound represented by Formula (X) or (1) described above is excluded). In a case where the composition contains the monomer, the crosslink density in the layer to be plated and the like can be appropriately controlled.

The monomer to be used is not particularly limited, and examples thereof include an addition-polymerizable compound such as a compound having an ethylenically unsaturated bond, a ring-opening-polymerizable compound such as a compound having an epoxy group, and the like. Among these, it is preferable to use a polyfunctional monomer, because then the crosslink density in the pattern-like layer to be plated is improved, and the adhesiveness of the pattern-like metal layer is further improved. The polyfunctional monomer means a monomer having two or more polymerizable groups. Specifically, it is preferable to use a monomer having two to six polymerizable groups.

From the viewpoint of the motility of molecules during a cross-linking reaction that affects the reactivity, the molecular weight of the polyfunctional monomer to be used is preferably 150 to 1,000, and more preferably 200 to 700. The number of atoms that represents the interval (distance) between a plurality of polymerizable groups is preferably 1 to 15, and more preferably equal to or greater than 6 and equal to or smaller than 10.

If necessary, other additives (for example, a sensitizer, a curing agent, a polymerization inhibitor, an antioxidant, an antistatic agent, an ultraviolet absorber, a filler, particles, a flame retardant, a surfactant, a lubricant, a plasticizer, and the like) may be added to the composition for forming a layer to be plated.

(Procedure of Step 1)

In step 1, first, the composition for forming a layer to be plated is disposed on the substrate. The method for disposing the composition is not particularly limited, and for example, it is possible to use a method of bringing the composition for forming a layer to be plated into contact with the surface of the substrate such that a coating film (a precursor layer of a layer to be plated) of the composition for forming a layer to be plated is formed. Examples of the method include a method (coating method) of coating the substrate with the composition for forming a layer to be plated.

In a case where the coating method is used, the method for coating the substrate with the composition for forming a layer to be plated is not particularly limited, and known methods (for example, spin coating, die coating, dip coating, and the like) can be used.

From the viewpoint of the handleability and the manufacturing efficiency, an aspect is preferable in which the coating film is formed by coating the substrate with the composition for forming a layer to be plated and, if necessary, removing the residual solvent by performing a drying treatment.

The condition of the drying treatment is not particularly limited. In view of further improving the productivity, the drying treatment is preferably performed for 1 to 30 minutes (preferably for 1 to 10 minutes) at room temperature to 220° C. (preferably at 50° C. to 120° C.).

The method for pattern-wise applying energy to the coating film on the substrate that contains the aforementioned compound is not particularly limited. For example, it is preferable to use a heating treatment, an exposure treatment (light irradiation treatment), and the like. Among these, an exposure treatment is preferable because it is finished within a short period of time. By applying energy to the coating film, the polymerizable group in the compound is activated, the compounds are cross-linked to each other, and the layer is cured.

In the exposure treatment, light irradiation performed using a UV lamp, visible rays, and the like is carried out. Examples of the light source include a mercury lamp, a metal halide lamp, a xenon lamp, a chemical lamp, a carbon arc lamp, and the like. Examples of radiation include electron beams, X-rays, ion beams, far infrared rays, and the like. As specific aspects, scanning exposure using an infrared laser, high-illuminance flash exposure using a xenon discharge lamp or the like, infrared ray lamp exposure, and the like can be suitably exemplified.

The exposure time varies with the reactivity of the compound and the light source, but is generally 10 seconds to 5 hours. The exposure energy may be about 10 to 8,000 mJ, and is preferably within a range of 50 to 3,000 mJ.

The method for pattern-wise performing the aforementioned exposure treatment is not particularly limited, and known methods can be adopted. For example, the coating film may be irradiated with exposure light through a mask.

In a case where a heating treatment is used for applying energy, it is possible to use a blast drier, an oven, an infrared drier, a heating drum, and the like.

Next, by removing a portion to which the energy is not applied within the coating film, a pattern-like layer to be plated is formed.

The aforementioned removing method is not particularly limited, and an optimal method is appropriately selected according to the compound to be used. For example, it is possible to select a method in which an alkaline solution (preferably with potential hydrogen (pH) of 13.0 to 13.8) is used as a developer. In a case where the region to which energy is not applied is removed using the alkaline solution, it is possible to adopt a method of immersing the substrate having the coating film, to which energy is applied, in the solution, a method of coating the substrate with the developer, and the like. Among these, the immersion method is preferable. In a case where the immersion method is used, from the viewpoint of the productivity, the workability, and the like, the immersion time is preferably about 1 minute to 30 minutes.

As another method, for example, it is possible to use a method of using a solvent, in which the aforementioned compound dissolves, as a developer and immersing the substrate in the developer.

(Pattern-Like Layer to be Plated)

The thickness of the pattern-like layer to be plated that is formed by the aforementioned treatments is not particularly limited. In view of the productivity, the thickness of the pattern-like layer to be plated is preferably 0.01 to 10 μm, more preferably 0.2 to 5 μm, and particularly preferably 0.3 to 3.0 μm.

The pattern shape of the pattern-like layer to be plated is not particularly limited, and is adjusted according to the place where the pattern-like metal layer is desired to be formed. For example, the pattern-like layer to be plated has a mesh pattern and the like. The shape of the lattice is not particularly limited, and may be a rhombic shape or a polygonal shape (for example, a triangular shape, a quadrangular shape, or a hexagonal shape). Furthermore, one side of each lattice may be linear, curved, or ark-like.

[Step 2: Step of Forming Pattern-Like Metal Layer]

Step 2 is a step of forming the pattern-like metal layer to be plated on the pattern-like layer to be plated by applying metal ions to the pattern-like layer to be plated formed in step 1, and performing a plating treatment on the pattern-like layer to be plated to which the metal ions are applied. By performing step 2, the pattern-like metal layer to be plated is disposed on the pattern-like layer to be plated.

Hereinafter, step 2 will be described by being divided into the step (step 2-1) of applying metal ions to the pattern-like layer to be plated and the step (step 2-2) of performing a plating treatment on the pattern-like layer to be plated to which the metal ions are applied.

(Step 2-1: Step of Applying Metal Ions)

In this step, first, metal ions are applied to the pattern-like layer to be plated. According to the function of the interactive group derived from the aforementioned compound, the applied metal ions are adsorbed onto (adhere to) the interactive group. More specifically, the metal ions are applied to both the inside and surface of the layer to be plated.

The metal ions can become a plating catalyst through a chemical reaction. More specifically, through a reduction reaction, the metal ions become a 0-valent metal which is a plating catalyst. In step 2-1, before the pattern-like layer to be plated is immersed in a plating bath (for example, an electroless plating bath) after the metal ions are applied to the pattern-like layer to be plated, the metal ions may be converted into a plating catalyst by being changed into a 0-valent metal through a reduction reaction performed separately. Alternatively, the metal ions may be immersed as they are in a plating bath and then changed into a metal (plating catalyst) by a reductant in the plating bath.

It is preferable that the metal ions are applied to the pattern-like layer to be plated by using a metal salt. The metal salt to be used is not particularly limited as long as it dissolves in an appropriate solvent and is dissociated into a metal ion and a base (anion). Examples of the metal salt include M(NO₃)ₙ, MClₙ, M_{2/n}(SO₄), M_{3/n}(PO₄) (M represents an n-valent metal atom), and the like. As the metal ions, those obtained as a result of the dissociation of the aforementioned metal salt can be suitably used. Specifically, examples of the metal ions include a Ag ion, a Cu ion, an Al ion, a Ni ion, a Co ion, a Fe ion, and a Pd ion. Among these, the ions that can form a multidentate ligand are preferable. Particularly, in view of the number of types of functional groups that can be coordinated and the catalytic ability of the functional groups, a Ag ion and a Pd ion are preferable. At the time of applying the metal ions, the pH of the solution applying the plating catalyst is preferably acidic.

As the method for applying metal ions to the pattern-like layer to be plated, for example, a metal salt is dissolved in an appropriate solvent so as to prepare a solution containing dissociated metal ions, and the pattern-like layer to be plated is coated with the solution. Alternatively, the substrate on which the pattern-like layer to be plated is formed is immersed in the solution.

As the aforementioned solvent, water or an organic solvent is appropriately used. As the organic solvent, a solvent which can permeate the pattern-like layer to be plated is preferable, and for example, acetone, methyl acetoacetate, ethyl acetoacetate, ethylene glycol diacetate, cyclohexanone, acetylacetone, acetophenone, 2-(1-cyclohexenyl)cyclohexanone, propylene glycol diacetate, triacetin, diethylene glycol diacetate, dioxane, N-methylpyrrolidone, dimethyl carbonate, dimethyl cellosolve, and the like can be used.

The metal ion concentration in the solution is not particularly limited, but is preferably 0.001% to 50% by mass and more preferably 0.005% to 30% by mass.

Furthermore, the contact time is preferably about 30 seconds to 24 hours, and more preferably about 1 minute to 1 hour.

The amount of the metal ions adsorbed onto the layer to be plated varies with the type of the plating bath to be used, the type of the catalyst metal, the type of the interactive group of the pattern-like layer to be plated, the method of use, and the like. From the viewpoint of the precipitating properties of plating, the amount of the metal ions adsorbed onto the layer to be plated is preferably 5 to 1,000 mg/m², more preferably 10 to 800 mg/m², and particularly preferably 20 to 600 mg/m².

(Step 2-2: Step of Plating Treatment)

Next, a plating treatment is performed on the pattern-like layer to be plated to which the metal ions are applied. The method of the plating treatment is not particularly limited, and examples thereof include an electroless plating treatment and an electrolytic plating treatment (electroplating treatment). In step 2-2, the electroless plating treatment may be performed alone, or, the electroless plating treatment is performed and then the electrolytic plating treatment may be performed.

In the present specification, a so-called silver mirror reaction is regarded as a kind of the aforementioned electroless plating treatment. Accordingly, for example, by reducing the metal ions adhering to the layer through the silver mirror reaction or the like, a desired pattern-like metal layer may be formed, or the electrolytic plating treatment may be additionally performed after the silver mirror reaction.

Hereinafter, the procedure of the electroless plating treatment and the electrolytic plating treatment will be specifically described.

The electroless plating treatment refers to an operation of precipitating a metal through a chemical reaction by using a solution in which metal ions desired to be precipitated as plating are dissolved.

In step 2-2, the electroless plating treatment is performed by, for example, rinsing the substrate including the pattern-like layer to be plated, to which the metal ions are applied, with water such that the surplus metal ions are removed, and then immersing the substrate in an electroless plating bath. As the electroless plating bath, known electroless plating baths can be used. In the electroless plating bath, the metal ions are reduced, and then electroless plating is performed.

The metal ions in the pattern-like layer to be plated can also be reduced through another step before the electroless plating treatment by additionally preparing a catalyst activating solution (reducing solution) unlike in the aspect in which the electroless plating solution is used as described above. The catalyst activating solution is a solution in which a reductant capable of reducing the metal ions into a 0-valent metal is dissolved. The concentration of the reductant with respect to the entirety of the solution is preferably 0.1% to 50% by mass, and more preferably 1% to 30% by mass. As the reductant, it is possible to use boron-based reductants such as sodium borohydride and dimethylamine borane and reductants such as formaldehyde and hypophosphoric acid.

At the time of immersion, it is preferable to immerse the substrate in the solution with stirring or shaking.

The general electroless plating bath is mainly composed of, in addition to a solvent (for example, water), 1. metal ions for plating, 2. reductant, 3. additive (stabilizer) for improving the stability of metal ions. The plating bath may contain known additives such as a plating bath stabilizer in addition to the above.

The organic solvent used in the electroless plating bath needs to be a solvent soluble in water. Accordingly, ketones such as acetone and alcohols such as methanol, ethanol, and isopropanol are preferably used. As the type of the metal used in the electroless plating bath, copper, tin, lead, nickel, gold, silver, palladium, and rhodium are known. Among these, from the viewpoint of conductivity, copper, silver, and gold are preferable, and copper is more preferable. According to the aforementioned metals, optimal reductant and additive are selected.

The time of immersion in the electroless plating bath is preferably about 1 minute to 6 hours, and more preferably about 1 minute to 3 hours.

The electrolytic plating treatment refers to an operation of precipitating a metal by an electric current by using a solution in which metal ions desired to be precipitated as plating are dissolved.

As described above, in step 2-2, after the electroless plating treatment, if necessary, the electrolytic plating treatment can be performed. In such an aspect, the thickness of the pattern-like metal layer to be formed can be appropriately adjusted.

As the electrolytic plating method, the methods known in the related art can be used. Examples of metals used for the electrolytic plating include copper, chromium, lead, nickel, gold, silver, tin, zinc, and the like. From the viewpoint of conductivity, copper, gold, and silver are preferable, and copper is more preferable.

The film thickness of the pattern-like metal layer obtained by the electrolytic plating can be controlled by adjusting the concentration of the metal contained in the plating bath, the current density, and the like.

The thickness of the pattern-like metal layer formed by the aforementioned procedure is not particularly limited, and optional thickness is selected according to the purpose of use. In view of conduction characteristics, the thickness of the pattern-like metal layer is preferably equal to or greater than 0.1 μm, more preferably equal to or greater than 0.5 μm, and even more preferably 1 to 30 μm.

The type of the metal constituting the pattern-like metal layer is not particularly limited, and examples of the metal include copper, chromium, lead, nickel, gold, silver, tin, zinc, and the like. From the viewpoint of conductivity, copper, gold, and silver are preferable, and copper and silver are more preferable.

The pattern shape of the pattern-like metal layer is not particularly limited. Because the pattern-like metal layer is disposed on the pattern-like layer to be plated, the pattern shape thereof is adjusted according to the pattern shape of the pattern-like layer to be plated.

The pattern-like layer to be plated having undertone the aforementioned treatments contains metal particles generated as a result of the reduction of the metal ions. The metal particles are dispersed at high density in the pattern-like layer to be plated. Furthermore, as described above, the interface between the pattern-like layer to be plated and the pattern-like metal layer forms a complicated shape, and due to the influence of such an interface shape, the pattern-like metal layer is visually recognized as a darker black layer.

In the present invention, a coating layer may be provided on the formed pattern-like metal layer. Particularly, in a case where a layer constitution is adopted in which the surface of the pattern-like metal layer is directly seen, by blackening the surface of the pattern-like metal layer, an effect of reducing the metal luster of the pattern-like metal layer and an effect of preventing copper color from noticed are obtained. In addition, a rust inhibition effect and a migration inhibition effect are also obtained.

As the blackening method, there are a lamination method and a substitution method. As the lamination method, known methods called blackening plating and the like are used, and examples thereof include a method of laminating a coating layer (blackening layer). In this method, NIKKA BLACK (manufactured by NIHON KAGAKU SANGYO CO., LTD.), an EBONYCHROME 85 series (manufactured by Metal Finishing Laboratory Co., Ltd.), and the like can be used. Examples of the substitution method include a method of preparing a coating layer (blackening layer) by sulfidizing or oxidizing the surface of the pattern-like metal layer and a method of preparing a coating layer (blackening layer) by substituting the surface of the pattern-like metal layer with a more precious metal. In the sulfidizing method, ENPLATE MB438A (manufactured by Meltex, Inc.) and the like can be used, and in the oxidizing method, PROBOND 80 (manufactured by Rohm and Hass Electronic Materials LLC) and the like can be used. In the substitution plating with a precious metal, palladium can be used.

<Laminate>

Through the aforementioned steps, a conductive laminate is formed which includes a substrate which has two main surfaces, a pattern-like layer to be plated which is disposed on at least one of the main surfaces of the substrate and formed by pattern-wise applying energy to the aforementioned composition for forming a layer to be plated, and a pattern-like metal layer which is disposed on the pattern-like layer to be plated and formed by performing a plating treatment.

In the conductive laminate, the pattern-like layer to be plated and the pattern-like metal layer may be disposed on only one of the main surfaces of the substrate or on both of two main surfaces of the substrate. In a case where the pattern-like layer to be plated and the pattern-like metal layer are disposed on both surfaces of the substrate, step 1 and step 2 may be performed on both surfaces of the substrate.

In a case where the laminate is used in the present invention, sometimes an overcoat layer, an optically transparent layer, and the like are adjacent to the laminate as an adjacent layer. For the purpose of preventing the rust of copper, to the adjacent layers, linear alkyl dicarboxylic acid such as undecanedioic acid, dodecanedioic acid, and tridecanedioic acid, phosphoric acid ester compounds such as monomethyl phosphate and monoethyl phosphate, pyridine-based compounds such as quinaldic acid, triazole-based compounds such as triazole, carboxybenzotriazole, benzotriazole, and naphthol triazole, tetrazoles such as 1H-tetrazole, tetrazole-based compounds such as benzotetrazole, bisphenol-based compounds such as 4,4′-butylidenebis-(6-tert-butyl-3-methylphenol), hindered phenol-based compounds such as pentaerythritol-tetrakis[3-(3,5-di-t-butyl-4-hydroxyphenyl)propionate], salicylic acid derivative-based compounds, hydrazide derivatives, aromatic phosphoric acid esters, thioureas, compounds having a mercapto group such as tolutriazole, 2-mercaptobenzoxazolethiol, methyl benzothiazole, and mercaptothiazoline, and triazine ring compounds may be added.

Furthermore, cyclic compounds such as crown ether and a cyclic phosphorus compound may be added to the adjacent layer.

In addition, to the adjacent layer, anionic surfactants such as an alkylbenzene sulfonic acid salt, a linear alkylbenzene sulfonic acid salt, a naphthalene sulfonic acid salt, and an alkenyl succinic acid salt, water-soluble polymers having properties of a Lewis acid such as PVP, and sulfonic acid group-containing polymers such as an arylsulfonic acid/salt polymer, polystyrene sulfonate, polyallyl sulfonate, polymethallyl sulfonate, polyvinyl sulfonate, polyisoprene sulfonate, an acrylic acid-3-sulfopropyl homopolymer, a methacrylic acid-3-sulfopropyl homopolymer, and a 2-hydroxy-3-acrylamidepropane sulfonic acid homopolymer may be added.

To the adjacent layer, hydrated antimony pentoxide, an aluminum coupling agent, a metal chelate compound such as zirconium alkoxide, a zinc compound, an aluminum compound, a barium compound, a strontium compound, and a calcium compound may also be added. As the zinc compound, there are zinc phosphate, zinc molybdate, zinc borate, zinc oxide, and the like. As the aluminum compound, there are aluminum dihydrogen tripolyphosphate, aluminum molybdate, and the like. As the barium compound, there are barium metaborate and the like. As the strontium compound, there are strontium carbonate, strontium oxide, strontium acetate, strontium metaborate, metal strontium, and the like. As the calcium compound, there are calcium phosphate, and calcium molybdate.

Furthermore, an oxidant such as ammonium persulfate, potassium persulfate, or hydrogen peroxide may be added to the adjacent layer.

In addition, dichloroisocyanurate and sodium metasilicate pentahydrate may be added to the adjacent layer in combination.

It is also possible to use known copper corrosion inhibitors. Moreover, two or more kinds of these compounds may be used in combination.

By coating the periphery of the pattern-like metal layer with a composition containing the copper corrosion inhibitors, the corrosion may be inhibited.

The substrate may further include a primer layer. In a case where the primer layer is disposed between the substrate and the pattern-like layer to be plated, the adhesiveness between the substrate and the pattern-like layer to be plated is further improved.

The thickness of the primer layer is not particularly limited. Generally, the thickness of the primer layer is preferably 0.01 to 100 μm, more preferably 0.05 to 20 μm, and even more preferably 0.05 to 10 μm.

The material of the primer layer is not particularly limited, and is preferably a resin which exhibits excellent adhesiveness with respect to the substrate. Specifically, for example, the resin may be a thermosetting resin, a thermoplastic resin, or a mixture of these. Examples of the thermosetting resin include an epoxy resin, a phenol resin, a polyimide resin, a polyester resin, a bismaleimide resin, a polyolefin-based resin, an isocyanate-based resin, and the like. Examples of the thermoplastic resin include a phenoxy resin, polyether sulfone, polysulfone, polyphenylene sulfone, polyphenylene sulfide, polyphenyl ether, polyether imide, an acrylonitrile-butadiene-styrene copolymer (ABS resin), and the like.

One kind of thermosetting resin and one kind of thermoplastic resin may be used singly, or two or more kinds of each may be used in combination. Furthermore, a resin containing a cyano group may also be used, and specifically, an ABS resin and “polymer containing a unit having a cyano group on a side chain” described in paragraphs “0039” to “0063” in JP2010-84196A may be used.

In addition, rubber components such as acrylonitrile-butadiene rubber (NBR rubber) and styrene-butadiene rubber (SBR rubber) can also be used.

As a suitable aspect of the material constituting the primer layer, a polymer can be exemplified which has a conjugated diene compound unit that may be hydrogenated. The conjugated diene compound unit means a repeating unit derived from a conjugated diene compound. The conjugated diene compound is not particularly limited as long as it is a compound having a molecular structure having two carbon-carbon double bonds separated by one single bond.

As a suitable aspect of the repeating unit derived from the conjugated diene compound, a repeating unit can be exemplified which is generated by a polymerization reaction of a compound having a butadiene skeleton.

The conjugated diene compound unit may be hydrogenated. It is preferable that the aforementioned polymer contains a hydrogenated conjugated diene compound unit, because then the adhesiveness of the pattern-like metal layer is further improved. That is, the double bonds in the repeating unit derived from the conjugated diene compound may be hydrogenated.

The polymer having the conjugated diene compound unit that may be hydrogenated may contain the aforementioned interactive group.

As suitable aspects of the polymer, acrylonitrile-butadiene rubber (NBR), carboxyl group-containing nitrile rubber (XNBR), acrylonitrile-butadiene-isoprene rubber (NBIR), an acrylonitrile-butadiene-styrene copolymer (ABS resin), hydrogenated substances of these (for example, hydrogenated acrylonitrile-butadiene rubber), and the like can be exemplified.

The primer layer may contain other additives (for example, a sensitizer, an antioxidant, an antistatic agent, an ultraviolet absorber, a filler, particles, a flame retardant, a surfactant, a lubricant, a plasticizer, and the like).

The method for forming the primer layer is not particularly limited, and examples thereof include a method of laminating a resin to be used on a substrate, a method of dissolving necessary components in a solvent that can dissolve the components, coating the surface of the substrate with the solution by a method such as coating, and drying the solution, and the like.

As the heating temperature and heating time in the coating method, the condition under which the coating solvent can be sufficiently dried may be selected. In view of manufacturing suitability, it is preferable to select a heating condition under which the heating temperature is equal to or lower than 200° C. and the heating time is within a range of 60 minutes, and it is more preferable to select a heating condition under which the heating temperature is 40° C. to 100° C. and the heating time is within a range of 20 minutes. As the solvent to be used, an optimal solvent (for example, cyclohexanone or methyl ethyl ketone) is appropriately selected according to the resin to be used.

In a case where a substrate on which the aforementioned primer layer is disposed is used, by performing step 1 and step 2 on the primer layer, a desired conductive laminate is obtained.

The touch sensor panel 10 may be provided with a functional layer such as an antireflection layer.

[Calender Treatment]

A calender treatment may be performed on the metal portion such that the metal portion is smoothed. In this way, the conductivity of the metal portion is markedly enhanced. The calender treatment can be performed using calender rolls. In a preferred aspect, the calender rolls generally consist of a pair of rolls.

As the rolls used in the calender treatment, plastic rolls of epoxy, polyimide, polyamide, polyimide amide, and the like or metal rolls are suitably used. Particularly, in a case where the substrate has emulsion layers on both surfaces, it is preferable to treat the substrate with metal rolls. In a case where the substrate has an emulsion layer on one surface, in view of preventing wrinkles, a metal roll and a plastic roll can be combined. The lower limit of the line pressure is preferably equal to or higher than 1,960 N/cm (200 kgf/cm which is 699.4 kgf/cm² (65.6 MPa) in a case of being converted into a surface pressure), and more preferably equal to or higher than 2,940 N/cm (300 kgf/cm which is 935.8 kgf/cm² (91.8 MPa) in a case of being converted into a surface pressure). The upper limit of the line pressure is equal to or lower than 6,880 N/cm (700 kgf/cm).

The application temperature of the smoothing treatment represented by the calender rolls is preferably 10° C. (no temperature adjustment) to 100° C. The temperature is more preferably within a range of about 10° C. (no temperature adjustment) to 50° C., although the temperature varies with the density or shape of lines drawn for forming a metal mesh pattern or a metal wiring pattern or with the type of binder. “10° C. (no temperature adjustment)” is a state where the temperature is not adjusted.

The present invention can be used by being appropriately combined with the techniques disclosed in the publications of unexamined applications and the pamphlets of international publications described in the following Tables 1 and 2. The marks such as “JP”, “No.”, and “Pamphlet No.” will not be listed.

TABLE 1

| | | | | |
|---|---|---|---|---|
| 2004-221564 | 2004-221565 | 2007-200922 | 2006-352073 | 2006-228469 |
| 2007-235115 | 2007-207987 | 2006-012935 | 2006-010795 | 2007-072171 |
| 2006-332459 | 2009-21153 | 2007-226215 | 2006-261315 | 2006-324203 |
| 2007-102200 | 2006-228473 | 2006-269795 | 2006-336090 | 2006-336099 |
| 2006-228478 | 2006-228836 | 2007-009326 | 2007-201378 | 2007-335729 |
| 2006-348351 | 2007-270321 | 2007-270322 | 2007-178915 | 2007-334325 |
| 2007-134439 | 2007-149760 | 2007-208133 | 2007-207883 | 2007-013130 |
| 2007-310091 | 2007-116137 | 2007-088219 | 2008-227351 | 2008-244067 |
| 2005-302508 | 2008-218784 | 2008-227350 | 2008-277676 | 2008-282840 |
| 2008-267814 | 2008-270405 | 2008-277675 | 2008-300720 | 2008-300721 |
| 2008-283029 | 2008-288305 | 2008-288419 | 2009-21334 | 2009-26933 |
| 2009-4213 | 2009-10001 | 2009-16526 | 2008-171568 | 2008-198388 |
| 2008-147507 | 2008-159770 | 2008-159771 | 2008-235224 | 2008-235467 |
| 2008-218096 | 2008-218264 | 2008-224916 | 2008-252046 | 2008-277428 |
| 2008-241987 | 2008-251274 | 2008-251275 | 2007-129205 | |

TABLE 2

| | | | | |
|---|---|---|---|---|
| 2006/001461 | 2006/088059 | 2006/098333 | 2006/098336 | 2006/098338 |
| 2006/098335 | 2006/098334 | 2007/001008 | | |

The present invention is basically constituted as above. Hitherto, the touch sensor panel and the substrate of the present invention have been specifically described, but the present invention is not limited to the aforementioned embodiments. It goes without saying that the present invention may be ameliorated or modified in various ways within a scope that does not depart from the gist of the present invention.

### EXPLANATION OF REFERENCES

10, 10a, 10b: touch sensor panel

11: main substrate

11a, 20a, 21a: front surface

12: touch sensor portion

12c: corner portion

12d: position

13: display device

14: control board

15, 19: flexible printed circuits

16: antenna

17: mobile terminal apparatus

18a: sensor portion

18b: peripheral wiring portion

20, 21: substrate

20b: rear surface

22, 26: adhesive layer

24: protective layer

30: first conductive layer

32: first wiring

35: conductive thin wire

37: cell

39: mesh pattern

40: second conductive layer

42: second wiring

50, 50a, 50b, 80, 80a, 80b, 80c: parasitic element

52, 52a, 52b, 54, 54a, 54b, 82, 82a, 82b: side

56, 58: conductor

60, 60a, 60b: set

70: antenna

72: ground wire

83, 83a, 83b: central axis

84: oblique side

85a: first side

85b: second side

90: dipole antenna

92: flexible substrate, substrate

C: straight line

C₁: straight line

C₂: straight line

Cn: straight line

Wₚₓ: linearly polarized wave

W_{py}: linearly polarized wave

d: line width

Pa: length

What is claimed is:

1. A touch sensor panel comprising:
a substrate;
a touch sensor portion provided on the substrate;
an antenna which is provided on the substrate and transmits and receives a linearly polarized wave; and
at least one L-shaped parasitic element provided on the substrate,
wherein the touch sensor portion includes a detection portion and a peripheral wiring portion, and
the L-shaped parasitic element has two sides intersecting at right angle and is disposed by presetting a length of each of the sides according to a frequency of the linearly polarized wave that the antenna transmits and receives.

2. A touch sensor panel comprising:
a substrate;
a touch sensor portion provided on the substrate;
an antenna which is provided near the substrate and transmits and receives a linearly polarized wave; and
at least one L-shaped parasitic element provided on the substrate,
wherein the touch sensor portion includes a detection portion and a peripheral wiring portion, and
the L-shaped parasitic element has two sides intersecting at right angle and is disposed by presetting a length of each of the sides according to a frequency of the linearly polarized wave that the antenna transmits and receives.

3. The touch sensor panel according to claim 1,
wherein the L-shaped parasitic element and the peripheral wiring portion are formed of the same material.

4. The touch sensor panel according to claim 1,
wherein two L-shaped parasitic elements that are rotationally symmetrical about the antenna are disposed on a front surface or a rear surface of the substrate.

5. The touch sensor panel according to claim 1,
wherein two L-shaped parasitic elements are rotationally symmetrically disposed on different surfaces of a front surface and a rear surface of the substrate.

6. The touch sensor panel according to claim 1,
wherein two L-shaped parasitic elements are provided,
the frequency of the linearly polarized wave corresponding to each of the parasitic elements is different for each of the parasitic elements, and
for each of the parasitic elements, the length of each of the sides is preset according to the frequency of the linearly polarized wave of the antenna.

7. The touch sensor panel according to claim 1,
wherein two sets each including two L-shaped parasitic elements that are rotationally symmetrically disposed are disposed on different surfaces of a front surface and a rear surface of the substrate,
the frequency of the linearly polarized wave corresponding to each of the sets is different for each of the sets, and
for each of the sets, the length of each of the sides of the parasitic elements is preset according to the frequency of the linearly polarized wave of the antenna.

8. A substrate disposed near an antenna which transmits and receives a linearly polarized wave, the substrate comprising:
at least one L-shaped parasitic element,
wherein the L-shaped parasitic element includes two sides which are formed of a material having conductivity and intersect at right angle, and
a length of each of the sides is preset according to a frequency of the linearly polarized wave that the antenna transmits and receives.

9. The substrate according to claim 8,
wherein two L-shaped parasitic elements that are rotationally symmetrical about the antenna are disposed on a front surface or a rear surface of the substrate.

10. The substrate according to claim 8,
wherein two L-shaped parasitic elements are rotationally symmetrically disposed on different surfaces of a front surface and a rear surface of the substrate.

11. The substrate according to claim 8,
wherein two L-shaped parasitic elements are provided,
the frequency of the linearly polarized wave corresponding to each of the parasitic elements is different for each of the parasitic elements, and
for each of the parasitic elements, the length of each of the sides is preset according to the frequency of the linearly polarized wave of the antenna.

12. The substrate according to claim 8,
wherein two sets each including two L-shaped parasitic elements that are rotationally symmetrically disposed are disposed on different surfaces of a front surface and a rear surface of the substrate,
the frequency of the linearly polarized wave corresponding to each of the sets is different for each of the sets, and
for each of the sets, the length of each of the sides of the parasitic elements is preset according to the frequency of the linearly polarized wave of the antenna.

13. The touch sensor panel according to claim 2,
wherein the L-shaped parasitic element and the peripheral wiring portion are formed of the same material.

14. The touch sensor panel according to claim 2,
wherein two L-shaped parasitic elements that are rotationally symmetrical about the antenna are disposed on a front surface or a rear surface of the substrate.

15. The touch sensor panel according to claim 2,
wherein two L-shaped parasitic elements are rotationally symmetrically disposed on different surfaces of a front surface and a rear surface of the substrate.

16. The touch sensor panel according to claim 2,
wherein two L-shaped parasitic elements are provided,
the frequency of the linearly polarized wave corresponding to each of the parasitic elements is different for each of the parasitic elements, and
for each of the parasitic elements, the length of each of the sides is preset according to the frequency of the linearly polarized wave of the antenna.

17. The touch sensor panel according to claim 2,
wherein two sets each including two L-shaped parasitic elements that are rotationally symmetrically disposed are disposed on different surfaces of a front surface and a rear surface of the substrate,
the frequency of the linearly polarized wave corresponding to each of the sets is different for each of the sets, and
for each of the sets, the length of each of the sides of the parasitic elements is preset according to the frequency of the linearly polarized wave of the antenna.
